(19) United States
(12) Patent Application Publication
(10) Pub. No.: US 2026/0116806 A1
(43) Pub. Date: Apr. 30, 2026

(54) Window Manufacturing Device And Window Manufacturing Method Using The Device

(71) Applicant: Samsung Display Co., Ltd., Yongin-si (KR)

(72) Inventors: Beomsoo Kim, Yongin-si (KR); Seungjun Lee, Yongin-si (KR); Seugpyo Hong, Yongin-si (KR)

(73) Assignee: Samsung Display Co., Ltd., Yongin-si (KR)

(21) Appl. No.: 19/360,367

(22) Filed: Oct. 16, 2025

(30) Foreign Application Priority Data
Oct. 25, 2024 (KR) 10-2024-0147216

(51) Int. Cl. C03B 17/06

(52) U.S. Cl. CPC C03B 17/065

(57) ABSTRACT

A window manufacturing device may include a melting unit configured to supply molten glass and a shape processing unit disposed adjacent to the melting unit in a direction in which the molten glass is discharged from the melting unit. The window manufacturing device may include a protruding portion that forms a groove in the preliminary glass discharged from the melting unit so that glass manufacturing and shape processing can be continuously performed, thereby improving the process quality of a manufactured window and increasing process economy.

### CROSS-REFERENCE TO RELATED APPLICATIONS

This U.S. non-provisional patent application claims priority under 35 U.S.C. § 119 of Korean Patent Application No. 10-2024-0147216, filed on Oct. 25, 2024, the entire contents of which are hereby incorporated by reference.

### TECHNICAL FIELD

The present disclosure herein relates to a window manufacturing device and a window manufacturing method, and more particularly, to a window manufacturing device for manufacturing a glass window including a partially slimmed region and a window manufacturing method using the device.

### BACKGROUND

Various types of electronic devices are being used to provide image information, and electronic devices including a flexible display panel capable of folding or bending have been developed recently. Unlike rigid electronic devices, flexible electronic devices can undergo various shape changes such as folding, rolling, or bending and have the characteristics of being portable without being limited to the screen size on which an image is displayed. Such flexible electronic devices require a window to protect the display panel without hindering the folding or bending operation. Accordingly, there is a need to develop a method and a device for manufacturing a window with excellent surface characteristics that ensure good folding properties without affecting display quality.

### SUMMARY

The present disclosure provides a method and a device for manufacturing a window with uniform surface characteristics.

The present disclosure also provides a glass window manufacturing method and a glass window manufacturing device, which have excellent process economy and easily control the shape of a slimming region of the window.

An aspect of the present disclosure provides a window manufacturing device including a melting unit configured to supply molten glass and a shape processing unit disposed adjacent to the melting unit in a direction, in which the molten glass is discharged, and including a protruding portion that forms a groove in semi-solidified preliminary glass after being discharged from the melting unit.

In an aspect, the shape processing unit may include a first sub-shape processing unit and a second sub-shape processing unit spaced apart from each other in the thickness direction of the preliminary glass with the preliminary glass interposed between the first sub-shape processing unit and the second sub-shape processing unit, wherein at least one of the first sub-shape processing unit or the second sub-shape processing unit incudes the at least one protruding portion.

In an aspect, the protruding portion may extend in a direction parallel to a discharge direction of the molten glass and protrude toward the preliminary glass so as to be able to transfer the shape of the protruding portion onto the preliminary glass.

In an aspect, the shape processing unit may include a protruding region, in which the protruding portion is disposed, and a first flat region and a second flat region including a flat surface and arranged to be spaced apart from each other with the protruding region interposed between the first flat region and the second flat region.

In an aspect, the shape processing unit may be fixedly disposed at a position spaced apart from the melting unit in the discharge direction by a predetermined distance.

In an aspect, the shape processing unit may form the groove in the preliminary glass and cool the preliminary glass.

In an aspect, the shape processing unit may include a roller including the protruding portion.

In an aspect, the roller may include a protruding region, in which the protruding portion is disposed, and a first flat region and a second flat region arranged to be spaced apart from each other with the protruding region interposed between the first flat region and the second flat region, and the diameter of the protruding region may be larger than the diameters of the first flat region and the second flat region.

In an aspect, the window manufacturing device may further include a cooling unit arranged to be spaced apart from the melting unit with the shape processing unit interposed between the cooling unit and the melting unit.

In an aspect, the shape processing unit may include a first sub-roller and a second sub-roller spaced apart from each other in the thickness direction of the preliminary glass with the preliminary glass interposed between the first sub-roller and the second sub-roller, wherein at least one of the first sub-roller or the second sub-roller includes the at least one protruding portion.

In an aspect, the first sub-roller and the second sub-roller may rotate with the preliminary glass interposed between the first sub-roller and the second sub-roller, transferring the shape of the protruding portion onto the preliminary glass and moving the preliminary glass.

In an aspect, the shape processing unit may include an upper shape processing unit and a lower shape processing unit sequentially disposed in a direction, in which the molten glass is discharged, and each including a protruding portion, and the protruding portion of the upper shape processing unit and the protruding portion of the lower shape processing unit may overlap each other in a direction in which the molten glass is discharged.

In an aspect, a micro pattern including a plurality of sub-protruding portions may be defined on the surface of the protruding portion.

In an aspect, the window manufacturing device may further include a transfer unit configured to move a solidified glass window after being processed in the shape processing unit.

In an aspect of the present disclosure, a window manufacturing method using a window manufacturing device including a melting unit and a shape processing unit including a protruding portion includes: providing glass raw materials to the melting unit to manufacture molten glass; discharging the molten glass from the melting unit to provide a semi-solidified preliminary glass to the shape processing unit; forming a groove in the preliminary glass using the protruding portion in the shape processing unit; and cooling the preliminary glass.

In an aspect, the forming of a groove in the preliminary glass and the cooling of the preliminary glass may be performed simultaneously in the shape processing unit.

In an aspect, the forming of a groove in the preliminary glass may include disposing the shape processing unit to be adjacent to the preliminary glass or operating the shape processing unit so that the shape of the protruding portion is transferred onto the preliminary glass.

In an aspect, the window manufacturing device may further include a cooling unit disposed after the shape processing unit, and the thickness of the window may be corrected in the cooling unit.

In an aspect, the providing of the preliminary glass to the shape processing unit may include continuously moving the preliminary glass from the melting unit to the shape processing unit in the discharge direction of the molten glass.

In an aspect, the forming of a groove in the preliminary glass may be continuously forming the groove in the preliminary glass by the protruding portion.

### BRIEF DESCRIPTION OF THE FIGURES

The accompanying drawings are included to provide a further understanding of the present disclosure, and are incorporated in and constitute a part of this specification. The drawings illustrate aspects of the present disclosure and, together with the description, serve to explain principles of the disclosure. In the drawings:

FIG. 1A is a perspective view illustrating an unfolded state of an electronic device according to an aspect of the present disclosure;

FIG. 1B is a perspective view illustrating an in-folding process of the electronic device according to an aspect of the present disclosure illustrated in FIG. 1A;

FIG. 1C is a perspective view illustrating an out-folding process of the electronic device according to an aspect of the present disclosure illustrated in FIG. 1A;

FIG. 2A is a perspective view illustrating an unfolded state of an electronic device according to an aspect of the present disclosure;

FIG. 2B is a perspective view illustrating an in-folding process of the electronic device according to an aspect of the present disclosure illustrated in FIG. 2A;

FIG. 2C is a perspective view illustrating an out-folding process of the electronic device according to an aspect of the present disclosure illustrated in FIG. 2A;

FIG. 3A is a perspective view of an electronic device according to an aspect of the present disclosure;

Each of FIG. 3B and FIG. 3C is a perspective view illustrating a multi-folded state of the electronic device according to an aspect of the present disclosure illustrated in FIG. 3A;

FIG. 4 is an exploded perspective view of an electronic device according to an aspect of the present disclosure;

FIG. 5 is a cross-sectional view of the electronic device according to an aspect of the present disclosure;

Each of FIGS. 6A to 6C is a cross-sectional view of a window according to an aspect of the present disclosure;

FIG. 7 is a block diagram of a window manufacturing device according to an aspect of the present disclosure;

FIG. 8 is a perspective view of a window manufacturing device according to an aspect of the present disclosure;

FIG. 9A is a perspective view of a shape processing unit according to an aspect of the present disclosure;

FIG. 9B is a cross-sectional view of the shape processing unit according to an aspect of the present disclosure;

FIG. 9C is a cross-sectional view of a shape processing unit according to an aspect of the present disclosure;

FIG. 10 is a perspective view of a window manufacturing device according to an aspect of the present disclosure;

FIG. 11A is a perspective view of a shape processing unit according to an aspect of the present disclosure;

FIG. 11B is a cross-sectional view of the shape processing unit according to an aspect of the present disclosure;

FIG. 12 is a cross-sectional view of the shape processing unit according to an aspect of the present disclosure;

FIG. 13A is a perspective view of a window manufacturing device according to an aspect of the present disclosure;

FIG. 13B is a perspective view of a shape processing unit according to an aspect of the present disclosure;

FIG. 14 is a flow chart of a window manufacturing method according to an aspect of the present disclosure;

FIG. 15 illustrates one step of the window manufacturing method according to an aspect of the present disclosure;

FIG. 16 illustrates one step of the window manufacturing method according to an aspect of the present disclosure; and

FIG. 17 is a cross-sectional view of a window manufactured by the window manufacturing method according to an aspect of the present disclosure.

### DETAILED DESCRIPTION

In the present disclosure, various modifications can be made, various forms can be used, and specific aspects will be illustrated in the drawings and described in detail in the text. However, this is not intended to limit the present disclosure to a specific form disclosed, and it will be understood that all changes, equivalents, or substitutes which fall in the spirit and technical scope of the present disclosure should be included.

In this specification, it will be understood that when an element (or region, layer, portion, etc.) is referred to as being “on”, “connected to” or “coupled to” another element, it can be directly on, connected or coupled to the other element, or intervening elements may be present.

Like reference numerals refer to like elements throughout. In addition, in the drawings, the thicknesses, ratios, and dimensions of elements are exaggerated for effective description of the technical contents. As used herein, the term “and/or” includes any and all combinations that the associated configurations can define.

It will be understood that, although the terms first, second, etc. may be used herein to describe various elements, these elements should not be limited by these terms. These terms are only used to distinguish one element from another element. For example, a first element could be termed a second element without departing from the scope of the present disclosure. Similarly, the second element may also be referred to as the first element. The terms of a singular form include plural forms unless otherwise specified.

In addition, terms, such as “below”, “lower”, “above”, “upper” and the like, are used herein for ease of description to describe one element's relation to another element(s) as illustrated in the figures. The above terms are relative concepts and are described based on the directions indicated in the drawings.

It will be understood that the terms “include” and/or “have”, when used in this specification, specify the presence of stated features, integers, steps, operations, elements, components and/or groups thereof, but do not preclude the presence or addition of one or more other features, integers, steps, operations, elements, components, and/or groups thereof.

In this specification, the expression “being directly disposed” may mean that there is no layer, film, region, plate, or the like which is added between a part of a layer, film, region, plate, or the like and another part. For example, the expression “being directly disposed” may mean being disposed between two layers or two members without an additional member such as an adhesive member interposed between the two layers or the two members.

Meanwhile, in this specification, the expression “a region/portion corresponds to another region/portion” means that “they overlap each other”, but the expression is not limited to having a same area and/or a same shape. In addition, in this specification, the expression “a region/portion overlaps another region/portion” includes a case in which the regions/portions indicated as overlapping each other when viewed on a plane at least partially overlap each other on a plane.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, an electronic device according to an aspect of the present disclosure, a window manufacturing device according to an aspect of the present disclosure, and a window manufacturing method according to an aspect of the present disclosure will be described with reference to the drawings.

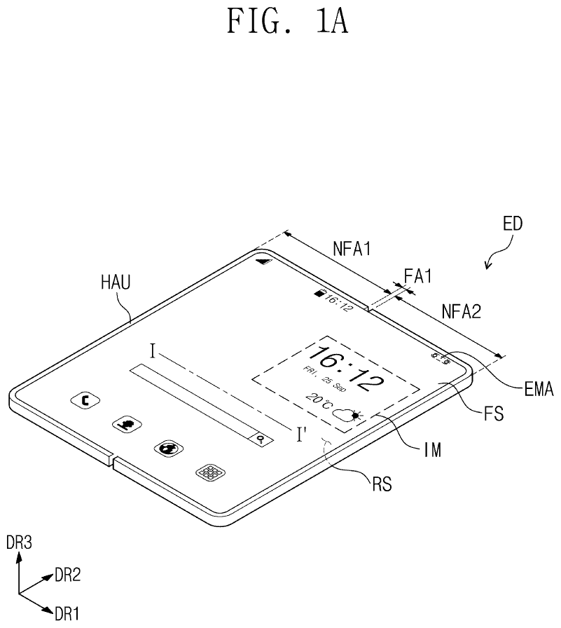

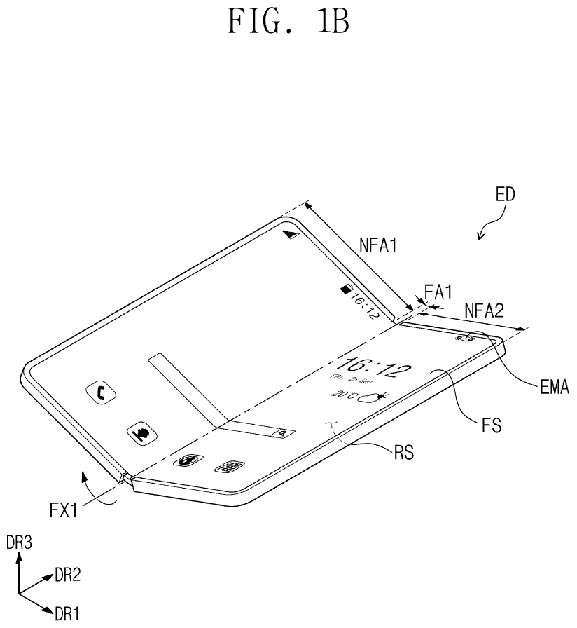

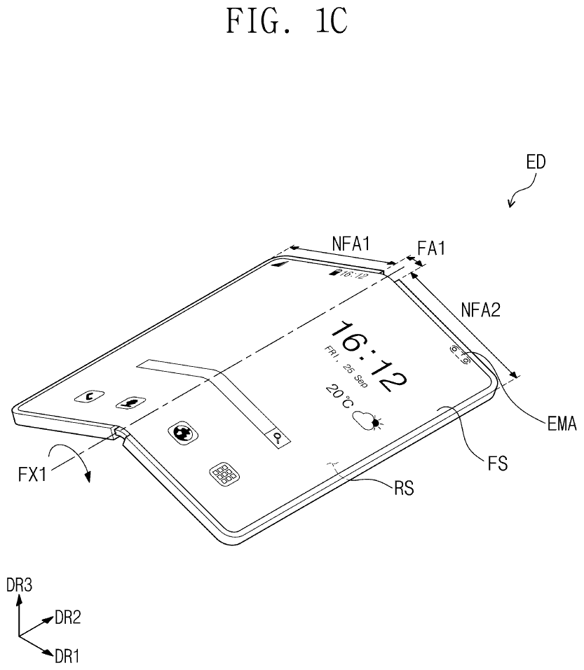

FIGS. 1A to 5 illustrate an electronic device according to an aspect of the present disclosure, and the electronic device according to an aspect of the present disclosure illustrated in FIGS. 1A to 5 includes a glass window manufactured by a window manufacturing device according to an aspect of the present disclosure and a window manufacturing method according to an aspect of the present disclosure, which will be described later. The glass window manufactured by the window manufacturing device according to an aspect of the present disclosure and the window manufacturing method according to an aspect of the present disclosure may also be referred to as a window.

FIG. 1A is a perspective view illustrating an unfolded state of an electronic device according to an aspect of the present disclosure. FIG. 1B is a perspective view illustrating an in-folding process of the electronic device illustrated in FIG. 1A. FIG. 1C is a perspective view illustrating an out-folding process of the electronic device illustrated in FIG. 1A.

The electronic device ED according to an aspect of the present disclosure may be activated according to an electrical signal. For example, the electronic device ED may be a mobile phone, a tablet, a car navigation system, a game console, or a wearable device, but the aspect of the present disclosure is not limited thereto. In the specification, as an example, the electronic device ED is illustrated as a mobile phone in FIG. 1A and the like.

Referring to FIGS. 1A to 1C, the electronic device ED according to an aspect of the present disclosure may include a first display surface FS defined by a first direction axis DR1 and a second direction axis DR2 crossing the first direction axis DR1. The electronic device ED may provide an image IM to a user through the first display surface FS. The electronic device ED according to an aspect of the present disclosure may display an image IM toward a third direction axis DR3 on the first display surface FS parallel to each of the first direction axis DR1 and the second direction axis DR2. In this specification, the front (or upper) and rear (or lower) surfaces of each component are defined based on the direction in which an image IM is displayed. The front and rear surfaces may be opposed to each other in the third direction axis DR3, and the normal direction of each of the front and rear surfaces may be parallel to the third direction axis DR3.

The electronic device ED according to an aspect of the present disclosure may include a first display surface FS and a second display surface RS. The first display surface FS may include an electronic module region EMA. The second display surface RS may be defined as a surface opposed to at least a portion of the first display surface FS. That is, the second display surface RS may be defined as a portion of the rear surface of the electronic device ED.

The electronic device ED according to an aspect of the present disclosure may sense an external input applied from the outside. The external input may include various types of inputs provided from the outside of the electronic device ED. For example, the external input may include not only a touch by a part of a user's body, such as the user's hand, but also an external input (e.g., hovering) applied in proximity to or adjacent to the electronic device ED at a predetermined distance. In addition, the external input may have various forms such as force, pressure, temperature, and light.

Meanwhile, in FIG. 1A and the drawings below, the first to third direction axes DR1 to DR3 are illustrated, and directions indicated by the first to third direction axes DR1, DR2, and DR3 described in this specification are relative concepts and may be converted into other directions. In addition, the directions indicated by the first to third direction axes DR1, DR2, and DR3 may be described as first to third directions, and the same reference numerals may be used for them.

The first display surface FS of the electronic device ED may include an active region which is activated according to an electrical signal. The electronic device ED according to an aspect of the present disclosure may display an image IM through the first display surface FS. In addition, various types of external inputs may be sensed on the first display surface FS.

The electronic device ED may include a folding region FA1 and non-folding regions NFA1 and NFA2. In an aspect of the present disclosure, the non-folding regions NFA1 and NFA2 may be disposed adjacent to the folding region FA1 with the folding region FA1 interposed between the non-folding regions NFA1 and NFA2. The electronic device ED according to an aspect of the present disclosure may include a first non-folding region NFA1 and a second non-folding region NFA2 arranged to be spaced apart from each other in the direction of the first direction axis DR1 with the folding region FA1 interposed between the first non-folding region NFA1 and the second non-folding region NFA2. For example, the first non-folding region NFA1 may be disposed on one side of the folding region FA1 along the first direction DR1, and the second non-folding region NFA2 may be disposed on the other side of the folding region FA1 along the first direction DR1.

Meanwhile, FIGS. 1A to 1C illustrate an aspect of the electronic device ED including one folding region FA1, but the aspects of the present disclosure are not limited thereto, and a plurality of folding regions may be defined in the electronic device ED. For example, the electronic device according to an aspect of the present disclosure may include two or more folding regions and may also include three or more non-folding regions with each of the folding regions interposed between the three or more non-folding regions.

Referring to FIG. 1B, the electronic device ED according to an aspect of the present disclosure may be folded based on a first folding axis FX1. The first folding axis FX1 is a virtual axis extending in the direction of the second direction axis DR2, and the first folding axis FX1 may be parallel to the long side of the electronic device ED. The first folding axis FX1 may extend along the second direction axis DR2 on the first display surface FS.

The electronic device ED may be folded based on the first folding axis FX1 and be transformed into an in-folded state in which one region of the first display surface FS overlapping the first non-folding region NFA1 and the other region of the first display surface FS overlapping the second non-folding region NFA2 face each other.

Meanwhile, when the electronic device ED according to an aspect of the present disclosure is in an in-folded state, the second display surface RS may be visible to a user. The second display surface RS may further include an electronic module region in which an electronic module including various components is disposed, and the second display surface RS is not limited to any one aspect.

Referring to FIG. 1C, the electronic device ED according to an aspect of the present disclosure may be folded based on the first folding axis FX1 and be transformed into an out-folded state in which one region of the second display surface RS overlapping the first non-folding region NFA1 and the other region of the second display surface RS overlapping the second non-folded region NFA2 face each other.

However, the aspect of the present disclosure is not limited thereto, and the electronic device ED may be folded based on a plurality of folding axes so that portions of the first display surface FS and the second display surface RS may face each other, and the number of folding axes and the number of non-folding regions according to the number of folding axes are not particularly limited.

Various electronic modules may be disposed in the electronic module region EMA. For example, the electronic modules may include at least any one of a camera, a speaker, a light sensor, or a heat sensor. The electronic module region EMA may sense an external object received through the first or second display surface FS or RS or provide the outside with a sound signal such as voice through the first or second display surface FS or RS. The electronic modules may include a plurality of components and are not limited to any one aspect.

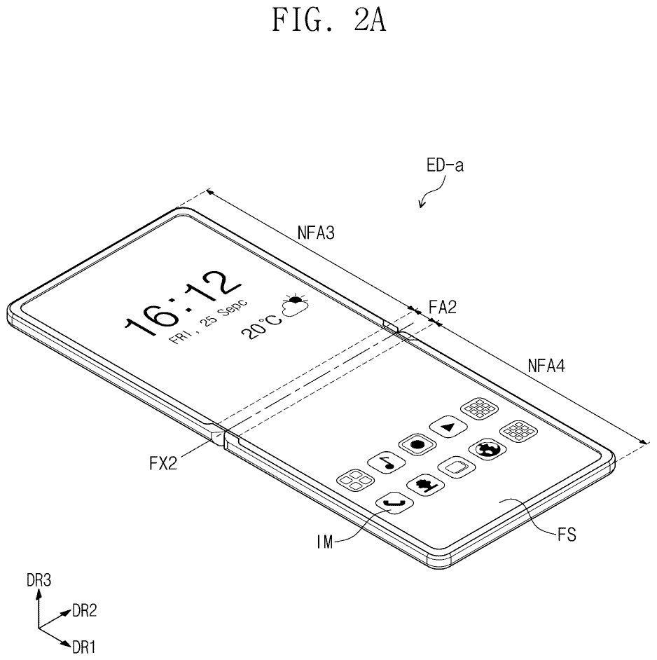

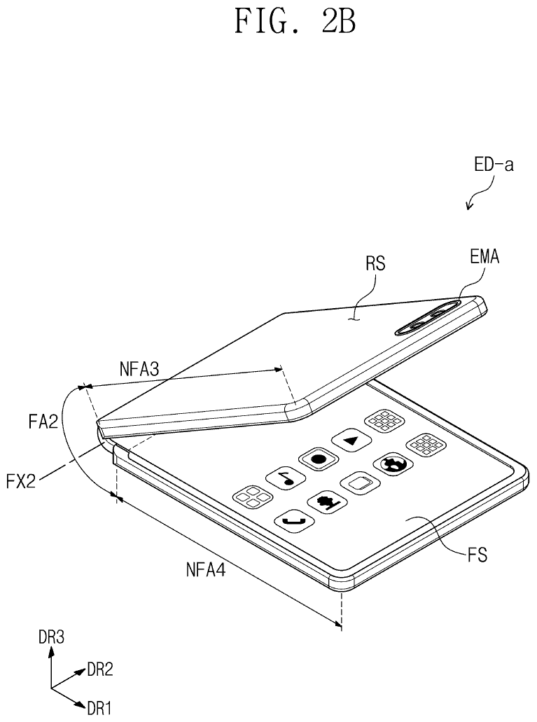

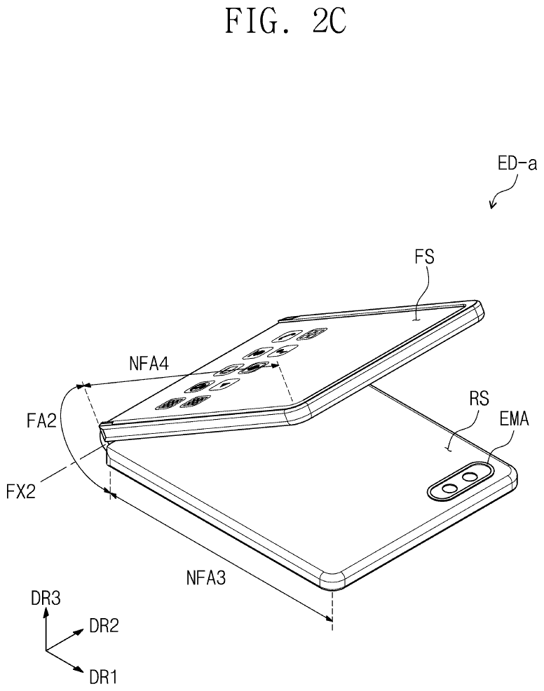

FIG. 2A is a perspective view illustrating an unfolded state of an electronic device according to an aspect of the present disclosure. FIG. 2B is a perspective view illustrating an in-folding process of the electronic device according to an aspect of the present disclosure illustrated in FIG. 2A. FIG. 2C is a perspective view illustrating an out-folding process of the electronic device according to an aspect of the present disclosure illustrated in FIG. 2A.

An electronic device ED-a according to an aspect of the present disclosure may be folded based on a second folding axis FX2 extending in one direction parallel to the second direction axis DR2. FIG. 2B illustrates a case in which the extension direction of the second folding axis FX2 is parallel to the extension direction of the short side of the electronic device ED-a. However, the aspect of the present disclosure is not limited thereto.

The electronic device ED-a according to an aspect of the present disclosure may include at least one folding region FA2 and non-folding regions NFA3 and NFA4 adjacent to the folding region FA2. The non-folding regions NFA3 and NFA4 may be arranged to be spaced apart from each other with the folding region FA2 interposed between the non-folding regions NFA3 and NFA4.

The folding region FA2 has a predetermined curvature and a predetermined curvature radius. In an aspect of the present disclosure, the first non-folding region NFA3 and the second non-folding region NFA4 may face each other, and the electronic device ED-a may be in-folded so that the first display surface FS is not exposed to the outside. In addition, referring to FIG. 2C, in an aspect of the present disclosure, the electronic device ED-a may be out-folded so that the first display surface FS is exposed to the outside.

The electronic device ED-a according to an aspect of the present disclosure may include a second display surface RS, and the second display surface RS may be defined as a surface opposed to at least a portion of the first display surface FS. The second display surface RS may include an electronic module region EMA in which an electronic module including various components is disposed. In addition, an image or video may be displayed on at least a portion of the second display surface RS.

Meanwhile, in an aspect of the present disclosure, when the electronic device ED-a is in an unfolded state, the first display surface FS may be visible to a user, and when the electronic device ED-a is in an in-folded state, the second display surface RS may be visible to a user.

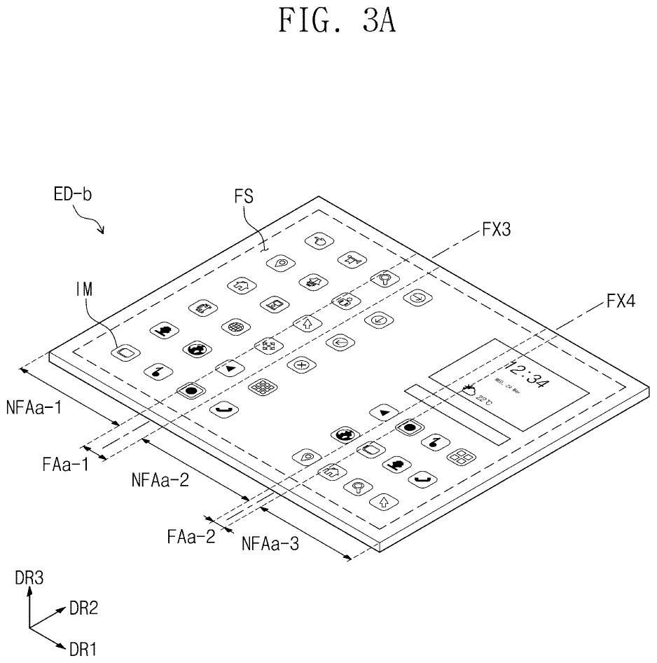

FIG. 3A is a perspective view of an electronic device ED-b according to an aspect of the present disclosure. Each of FIGS. 3B and 3C is a perspective view illustrating a multi-folded state of the electronic device ED-b illustrated in FIG. 3A.

Referring to FIGS. 3A to 3C, the electronic device ED-b according to an aspect of the present disclosure may be a multi-foldable device including a plurality of folding regions. The electronic device ED-b may include a plurality of folding regions FAa-1 and FAa-2 and a plurality of non-folding regions NFAa-1, NFAa-2, and NFAa-3. The electronic device ED-b according to an aspect of the present disclosure may include a first folding region FAa-1, a second folding region FAa-2, a first non-folding region NFAa-1, a second non-folding region NFAa-2, and a third non-folding region NFAa-3. In the first direction DR1, the first folding region FAa-1 is disposed between the first non-folding region NFAa-1 and the second non-folding region NFAa-2, and the second folding region FAa-2 is disposed between the second non-folding region NFAa-2 and the third non-folding region NFAa-3. FIGS. 3A to 3C exemplarily illustrate two folding regions FAa-1 and FAa-2 and three non-folding regions NFAa-1, NFAa-2, and NFAa-3, but the number of folding regions FAa-1 and FAa-2 and non-folding regions NFAa-1, NFAa-2, and NFAa-3 is not limited thereto and may be further increased.

Referring to FIGS. 3A and 3B, the first folding region FAa-1 may be folded with respect to a third folding axis FX3 parallel to the second direction DR2. The first folding region FAa-1 may be out-folded so that the rear surface of the second non-folding region NFAa-2 and the rear surface of the first non-folding region NFAa-1 face each other and the display surface of the first non-folding region NFAa-1 faces the outside. The second folding region FAa-2 may be folded with respect to a fourth folding axis FX4 parallel to the second direction DR2. The second folding region FAa-2 may be in-folded so that the display surface of the second non-folding region NFAa-2 and the display surface of the third non-folding region NFAa-3 face each other.

Referring to FIGS. 3A and 3C, the second folding region FAa-2 may be folded with respect to the fourth folding axis FX4 parallel to the second direction DR2. The display surface of the second non-folding region NFAa-2 may be in-folded so as to be disposed inside and face the display surface of the third non-folding region NFAa-3. The first folding region FAa-1 may be folded with respect to the third folding axis FX3 parallel to the second direction DR2. The first folding region FAa-1 may be in-folded so that the rear surface of the third non-folding region NFAa-3 and the display surface of the first non-folding region NFAa-1 face each other.

Meanwhile, the multi-folded states of the electronic device are not limited to the shapes illustrated in FIGS. 3B and 3C, and the electronic device may have various folding shapes.

In an aspect of the present disclosure, both an out-folding operation and an in-folding operation may occur simultaneously, and only one of the out-folding operation and the in-folding operation may occur.

In an aspect of the present disclosure, the electronic devices ED, ED-a, and ED-b may be configured so that in-folding and out-folding operations are alternately repeated from an unfolding operation, but the aspect of the present disclosure is not limited thereto. In an aspect of the present disclosure, the electronic devices ED, ED-a, and ED-b may be configured so that any one of an unfolding operation, an in-folding operation, and an out-folding operation is selected. In addition, when a plurality of folding regions are included, the folding direction of at least one of the plurality of folding regions may be different from the folding direction of the remaining folding regions. For example, when two folding regions are included, two non-folding regions with one folding region interposed between the two folding regions may be folded by an in-folding operation, and two non-folding regions with the other folding region interposed between the two non-folding regions may be folded by an out-folding operation.

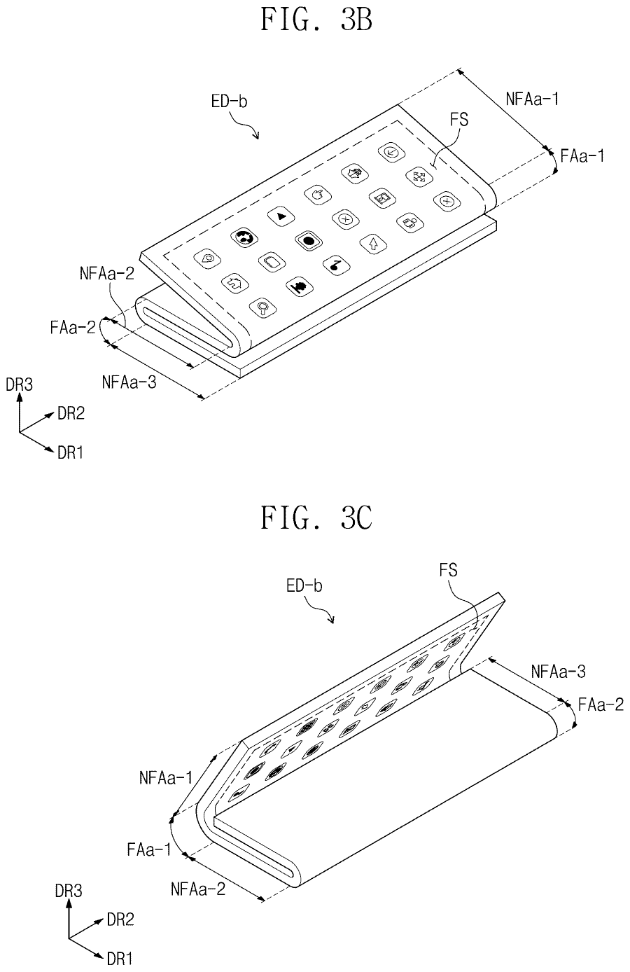

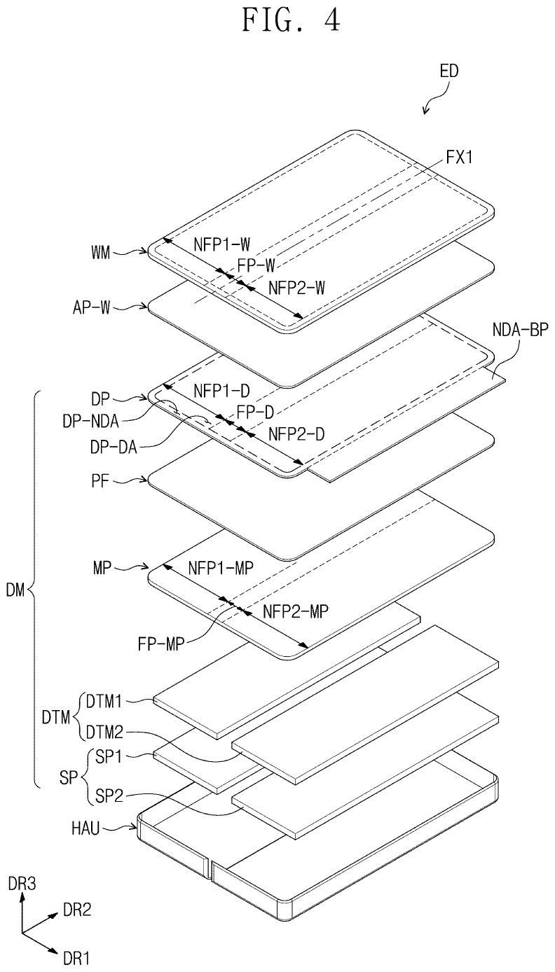

FIG. 4 is an exploded perspective view of an electronic device according to an aspect of the present disclosure. FIG. 5 is a cross-sectional view illustrating a portion of the electronic device according to an aspect of the present disclosure. FIG. 5 is a cross-sectional view illustrating a portion corresponding to line I-I′ of FIG. 1A.

Meanwhile, FIGS. 4, 5, and the like below illustrate a case in which the folding axis FX1 of the electronic device ED illustrated in FIG. 1A and the like is parallel to the long side of the electronic device ED, but the aspects of the present disclosure are not limited thereto, and the content described with reference to the drawings below may also be applied to a case in which the folding axis FX2 is parallel to the short side of the electronic device as illustrated in FIG. 2A and the like, or to a case in which the electronic device is multi-folded as illustrated in FIG. 3A and the like.

The electronic device ED according to an aspect of the present disclosure may include a display module DM, a window module WM, and a housing HAU configured to accommodate the display module DM and the window module WM. The electronic device ED may further comprise a window adhesive layer AP-W configured to couple the display module DM with the window module WM.

The display module DM may include a display panel DP and a lower module LM disposed below the display panel DP. The lower module LM may include a support plate MP. In addition, in an aspect of the present disclosure, the display module DM may further include at least one of a protective layer PF, a support member SP, adhesive layers AP1, AP2, AP3, and AP4, or a digitizer module DTM in addition to the support plate MP in the lower module LM.

The display panel DP may display an image according to an electrical signal and transmit/receive information on an external input. The display panel DP may include a display region DP-DA and a non-display region DP-NDA. The display region DP-DA may be defined as a region from which an image provided by the display panel DP is output.

The non-display region DP-NDA is adjacent to the display region DP-DA. For example, the non-display region DP-NDA may surround the display region DP-DA. However, this is illustrated as an example, and the non-display region DP-NDA may be defined in various shapes and is not limited to any one aspect. In addition, the display panel DP may include a non-display bending portion NDA-BP disposed on at least one side of the non-display region DP-NDA. The non-display bending portion NDA-BP may be bent toward the lower side of the display module DM and be disposed to overlap at least a portion of the display panel DP. A circuit layer, a connection line, a circuit board, or the like for displaying an image or transmitting/receiving information may be mounted on or attached to the non-display bending portion NDA-BP.

In an aspect of the present disclosure, the display panel DP includes a display layer EDL. The display layer EDL may be a component that substantially generates an image. The image generated by the display layer EDL may be viewed by a user from the outside through the first display surface FS (see FIG. 1A). The display layer EDL may be a light-emitting display layer, but is not particularly limited thereto. For example, the display layer EDL may be an organic light-emitting display layer or an inorganic light-emitting display layer. The organic light-emitting display layer may include a light-emitting element including an organic light-emitting material in a light-emitting layer. In addition, the inorganic light-emitting display layer may include a light-emitting element including materials such as quantum dots, quantum rods and the like in a light-emitting layer.

The display panel DP may further include a sensor layer ISL. The sensor layer ISL may be disposed directly on the display layer EDL. The sensor layer ISL may include a plurality of sensing electrodes. The sensor layer ISL may sense an external input by a self-cap method or a mutual cap method. The sensor layer ISL may sense an input by an active-type input device.

The sensor layer ISL may be formed directly on the display layer EDL through a continuous process when the display layer EDL is manufactured. However, the aspects of the present disclosure are not limited thereto, and the sensor layer ISL may be manufactured as a panel separate from the display layer EDL and then may be attached to the display layer EDL by an adhesive layer (not illustrated).

In addition, the display panel DP may further include an optical layer ROL. The optical layer ROL may function to reduce reflection of external light. For example, the optical layer ROL may include a polarizing layer or a color filter layer. However, the aspects of the present disclosure are not limited thereto, and the optical layer ROL may include optical members for improving the display quality of the display module DM.

In an aspect of the present disclosure, the optical layer ROL may be disposed directly on the sensor layer ISL. In addition, when the sensor layer ISL is omitted from the display panel DP, the optical layer ROL may be disposed directly on the display layer EDL. However, the aspects of the present disclosure are not limited thereto, and the optical layer ROL may be disposed on the display layer EDL or the sensor layer ISL using a separate adhesive member.

The display panel DP may include a folding display portion FP-D and non-folding display portions NFP1-D and NFP2-D. The folding display portion FP-D may correspond to the folding region FA1 (see FIG. 1A), and the non-folding display portions NFP1-D and NFP2-D may correspond to the non-folding regions NFA1 and NFA2 (see FIG. 1A). The folding display portion FP-D and the non-folding display portions NFP1-D and NFP2-D of the display panel DP may be respectively referred to as the folding display portion and the non-folding display portions of the display module DM.

The folding display portion FP-D may correspond to a portion that is folded or bent with respect to the folding axis FX1 (see FIG. 1A). The display panel DP may include a first non-folding display portion NFP1-D and a second non-folding display portion NFP2-D, and the first non-folding display portion NFP1-D and the second non-folding display portion NFP2-D may be spaced apart from each other in the first direction DR1 with the folding display portion FP-D interposed between the first non-folding display portion NFP1-D and the second non-folding display portion NFP2-D. The folding display portion FP-D may correspond to the folding region FA1 of the electronic device ED, and the first non-folding display portion NFP1-D and the second non-folding display portion NFP2-D may respectively correspond to the first non-folding region NFA1 and the second non-folding region NFA2 of the electronic device ED.

In an aspect of the present disclosure, the support plate MP may be disposed below the display panel DP. The support plate MP may include a folding support portion FP-MP and non-folding support portions NFP1-MP and NFP2-MP. A first non-folding support portion NFP1-MP and a second non-folding support portion NFP2-MP of the support plate MP may be spaced apart from each other in the first direction DR1 with the folding support portion FP-MP interposed between the first non-folding support portion NFP1-MP and the second non-folding support portion NFP2-MP. The folding support portion FP-MP may correspond to the folding region FA1 (see FIG. 1A), and the non-folding support portions NFP1-MP and NFP2-MP may correspond to the non-folding regions NFA1 and NFA2 (see FIG. 1A). The support plate MP may include a pattern portion PTA in which a plurality of openings OH are defined. The pattern portion PTA may be included in the folding support portion FP-MP. The folding or bending characteristics of the electronic device ED may be improved by disposing the pattern portion PTA so as to correspond to the folding region FA1.

In the display module DM according to an aspect of the present disclosure, the protective layer PF of the lower module LM may be disposed between the display panel DP and the support plate MP. The protective layer PF may be disposed below the display panel DP to protect the rear surface of the display panel DP. The protective layer PF may overlap the entire display panel DP. The protective layer PF may include a polymer material. For example, the protective layer PF may be a polyimide film or a polyethylene terephthalate film. However, this is an example and the material of the protective layer PF is not limited thereto.

In an aspect of the present disclosure, the lower module LM may include a support member SP. The support member SP may include support layers SP1 and SP2. The support layers SP1 and SP2 may include a first support layer SP1 and a second support layer SP2 spaced apart from each other in the direction of the first direction axis DR1. The first support layer SP1 and the second support layer SP2 may be spaced apart from each other in a portion corresponding to the first folding axis FX1 (see FIG. 1A). As the support layers SP1 and SP2 are spaced apart from each other in the folding region FA1 and provided as the first support layer SP1 and the second support layer SP2, it is possible to improve the folding or bending characteristics of the electronic device ED. Meanwhile, although not illustrated, the support layers SP1 and SP2 may further include a cushion layer (not illustrated) and a lower support plate (not illustrated) stacked in the thickness direction.

The electronic device ED according to an aspect of the present disclosure may further include a digitizer module DTM disposed below the support plate MP. The digitizer module DTM according to an aspect of the present disclosure may include a digitizer layer, a shielding layer, and the like. The digitizer module DTM may be included in the configuration of the lower module LM.

The digitizer module DTM may include a first digitizer module DTM1 and a second digitizer module DTM2 arranged to be spaced apart from each other in a portion overlapping the folding region FA1. The first digitizer module DTM1 may be disposed to correspond to the first non-folding region NFA1, and the second digitizer module DTM2 may be disposed to correspond to the second non-folding region NFA2

That is, in an aspect of the present disclosure, the first digitizer module DTM1 and the second digitizer module DTM2 may be spaced apart from each other in a region overlapping the folding display portion FP-D. The first digitizer module DTM1 may overlap the first non-folding display portion NFP1-D, and the second digitizer module DTM2 may overlap the second non-folding display portion NFP2-D.

In addition, the electronic device ED according to an aspect of the present disclosure may further include at least one of the adhesive layers AP1, AP2, AP3, and AP4. For example, a first adhesive layer AP1 may be disposed between the display panel DP and the protective layer PF, and a second adhesive layer AP2 may be disposed between the protective layer PF and the support plate MP. A third adhesive layer AP3 and a fourth adhesive layer AP4 may be disposed between the support plate MP and the support member SP. At least one of the adhesive layers AP1, AP2, AP3, and AP4 may be an optically transparent adhesive film or an optically transparent adhesive resin layer. However, the aspects of the present disclosure are not limited thereto, and at least one of the adhesive layers AP1, AP2, AP3, and AP4 may have a low transmittance of about 80% or less.

Meanwhile, FIGS. 4, 5, and the like illustrate that the lower module LM includes all of the protective layer PF, the support plate MP, the support member SP, the adhesive layers AP1, AP2, AP3, and AP4, and the digitizer module DTM, but the aspects of the present disclosure are not limited to what is illustrated, and the configuration of the lower module LM may include only some of the components listed above in consideration of the mechanical properties, shapes, and operating characteristics required for the electronic device ED, or more components may be added in addition to the components of the lower module presented above.

The electronic device ED according to an aspect of the present disclosure includes a window module WM disposed on the display module DM. The window module WM may include a folding portion FP-W and non-folding portions NFP1-W and NFP2-W. A first non-folding portion NFP1-W and a second non-folding portion NFP2-W of the window module WM may be spaced apart from each other in the first direction DR1 with the folding portion FP-W interposed between the first non-folding portion NFP1-W and the second non-folding portion NFP2-W. The folding portion FP-W may correspond to the folding region FA1 of the electronic device ED (see FIG. 1A), and the non-folding portions NFP1-W and NFP2-W may correspond to the non-folding regions NFA1 and NFA2. In addition, the folding portion FP-W may correspond to the folding display portion FP-D, and the non-folding portions NFP1-W and NFP2-W may correspond to the non-folding display portions NFP1-D and NFP2-D.

The window module WM may cover the entire upper surface of the display module DM. In an aspect of the present disclosure, the window module WM may be used as a cover window of the electronic device ED. In an aspect of the present disclosure, the window module WM may correspond to the uppermost member of the electronic device ED.

In an aspect of the present disclosure, the window module WM may include a window WP and a resin layer RL. The resin layer RL may be disposed on the upper surface or lower surface of the window WP. In a drawing of this specification, the resin layer RL is illustrated as being disposed on the lower surface of the window WP, but the aspects of the present disclosure are not limited thereto, and the resin layer RL may be disposed on the upper surface of the window WP, or the resin layer RL may be disposed to cover the upper and side surfaces of the window WP.

In an aspect of the present disclosure, the resin layer RL may be formed of an organic resin. In addition, unlike this, the resin layer RL may be formed of a composite resin including both an organic material and an inorganic material.

In an aspect of the present disclosure, the window WP may be a tempered glass substrate. The window WP may be an ultra-thin tempered glass substrate. The window WP may have flexibility that allows its state to be easily changed by folding or bending.

In an aspect of the present disclosure, the window WP may include a slimming region having a smaller average thickness than the other portions, and the slimming region may be disposed to correspond to the folding region FA1 of the electronic device. FIG. 5 exemplarily illustrates the electronic device ED including one folding region FA1, but when a plurality of folding regions are included therein, the window WP may include slimming regions respectively corresponding to the folding regions. As the slimming region is included in the window WP, the electronic device ED may exhibit excellent folding or bending operation characteristics.

The window WP according to an aspect of the present disclosure may be a glass window manufactured by a window manufacturing device according to an aspect of the present disclosure and a window manufacturing method according to an aspect of the present disclosure, which will be described later.

Each of FIGS. 6A to 6C is a cross-sectional view of a window according to an aspect of the present disclosure. Windows WP and WP-a illustrated in FIGS. 6A and 6B differ in the shapes of grooves CCP and CCP-a formed in a slimming region SLA. In addition, the number of grooves CCP-b1 and CCP-b2 of a window WP-b illustrated in FIG. 6C is different from the number of the groove of the window WP illustrated in FIG. 6A.

The window WP and WP-a according to an aspect of the present disclosure illustrated in FIGS. 6A and 6B may include a folding portion FP and a first non-folding portion NFP1 and a second non-folding portion NFP2 spaced apart from each other in the first direction DR1 with the folding portion FP interposed between the first non-folding portion NFP1 and the second non-folding portion NFP2.

The groove CCP or CCP-a may be a portion formed by being concavely recessed from at least one of the upper or lower surface of the window. The groove CCP or CCP-a may be defined in the folding portion FP or FP-a. In FIG. 5, the groove CCP or CCP-a of the window WP is illustrated as being disposed in a direction away from the upper surface of the display panel DP, but the aspects of the present disclosure are not limited thereto, and in an aspect of the present disclosure, the window WP or WP-a may be disposed so that the recessed portion CCP or CCP-a is concavely recessed in the direction of the display panel DP.

The slimming region SLA in which the groove CCP or CCP-a is formed corresponds to a portion that is relatively thinner than the first non-folding portion NFP1 and the second non-folding portion NFP2 of the window. The groove CCP or CCP-a may be formed in a shape that extends in the second direction DR2. The extension direction of the groove CCP or CCP-a may correspond to the extension direction of the folding axis FX1 (see FIG. 4).

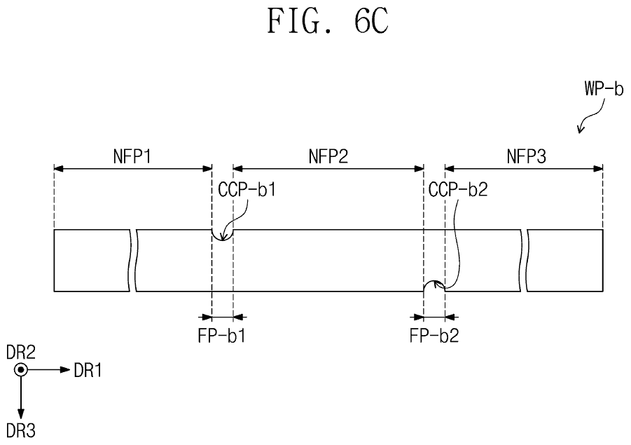

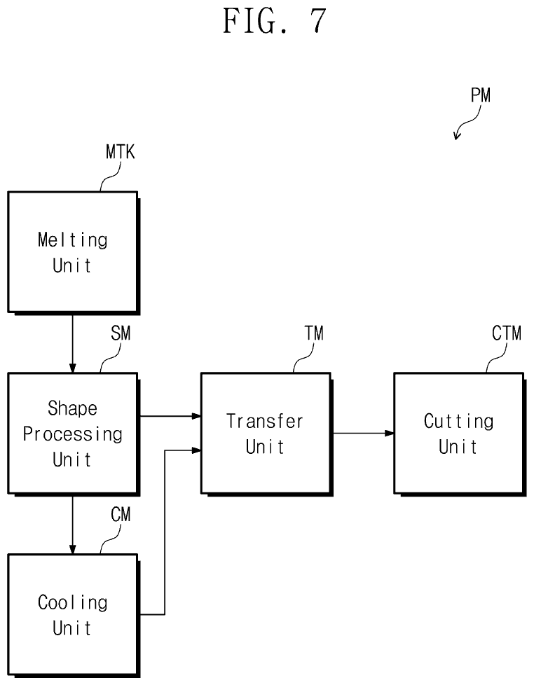

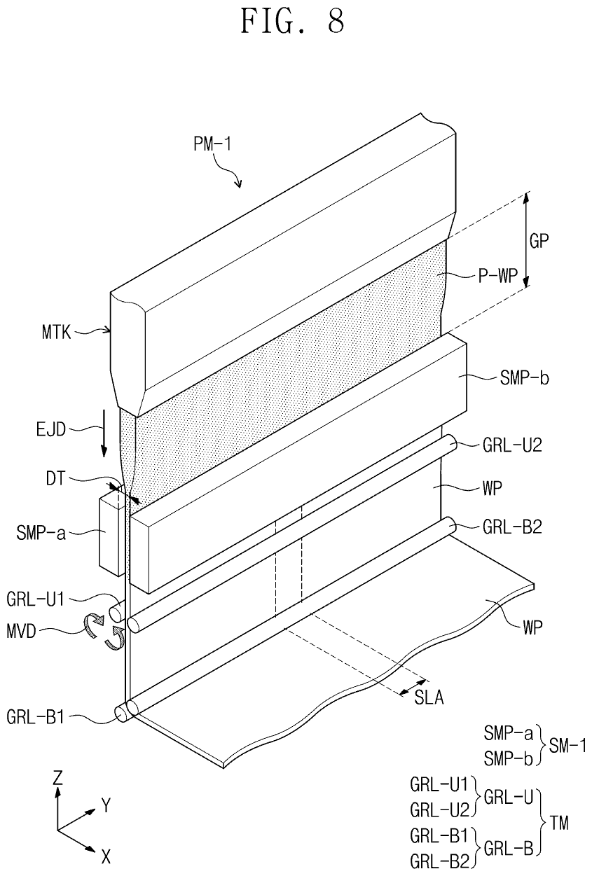

An edge portion EDP of the groove CCP or CCP-a that is the boundary of the slimming region SLA may correspond to the boundary of a protruding portion EP (see FIG. 9A) in the window manufacturing device according to an aspect of the present disclosure, which will be described later.

The window WP or WP-a according to an aspect of the present disclosure illustrated in FIGS. 6A and 6B is described as having the groove CCP or CCP-a defined only on one surface (upper or lower surface) of the window, but the aspects of the present disclosure are not limited thereto, and the window WP or WP-a according to an aspect of the present disclosure may have a groove defined on both the upper surface and the lower surface in the slimming region SLA.

Referring to FIG. 6C, the window WP-b according to an aspect of the present disclosure may include a first non-folding portion NFP1, a second non-folding portion NFP2, and a third non-folding portion NFP3 that are arranged to be spaced apart from each other in the first direction DR1. The window WP-b according to an aspect of the present disclosure may include a first folding portion FP-b1 disposed between the first non-folding portion NFP1 and the second non-folding portion NFP2 and a second folding portion FP-b2 disposed between the second non-folding portion NFP2 and the third non-folding portion NFP3. The window WP-b according to an aspect of the present disclosure may include a first groove CCP-b1 defined in the first folding portion FP-b1 and a second groove CCP-b2 defined in the second folding portion FP-b2.

In the window WP-b according to an aspect of the present disclosure, the first groove CCP-b1 and the second groove CCP-b2 may be defined on different surfaces and may not overlap each other. However, the aspects of the present disclosure are not limited thereto, and the first groove CCP-b1 and the second groove CCP-b2 may be defined on the same surface as each other. Meanwhile, a portion on which the first groove CCP-b1 and the second groove CCP-b2 are defined may also be referred to as a slimming region.

The window WP-b according to an aspect of the present disclosure illustrated and described in FIG. 6C may be used as the window of the electronic device ED-b including a plurality of folding portions described with reference to FIGS. 3A to 3C.

The groove CCP, CCP-a, CCP-b1, or CCP-b2 defined in the window WP, WP-a, or WP-b according to an aspect of the present disclosure illustrated in FIGS. 6A to 6C may correspond to the protruding portion included in the shape processing unit in the window manufacturing device according to an aspect of the present disclosure and the window manufacturing method according to an aspect of the present disclosure using the device, which will be described later. In the window WP, WP-a, or WP-b according to an aspect of the present disclosure, the width, depth, and position of the groove CCP, CCP-a, CCP-b1, or CCP-b2 may be changed according to folding or bending characteristics required in the electronic device. In addition, the width, depth, and position of the groove CCP, CCP-a, CCP-b1, or CCP-b2 may be controlled according to the shape and position of the protruding portion in the window manufacturing device and the window manufacturing method according to an aspect of the present disclosure, which will be described later.

Referring to FIGS. 6A and 6C, the groove CCP, CCP-b1, or CCP-b2 of the window WP or WP-b according to an aspect of the present disclosure may include a curved surface having a predetermined curvature radius.

In an aspect of the present disclosure illustrated in FIG. 6A, the groove CCP may have a concavely recessed shape based on a flat surface which is the upper surface of the first non-folding portion NFP1 and the second non-folding portion NFP2. The groove CCP may be defined as a continuous curved surface shape extending in the second direction DR2 between the first non-folding portion NFP1 and the second non-folding portion NFP2 spaced apart from each other in the first direction DR1.

In addition, in an aspect of the present disclosure illustrated in FIG. 6C, the first groove CCP-b1 may have a concavely recessed shape based on the upper surface of the first non-folding portion NFP1 and the second non-folding portion NFP2, which is a flat surface, and the second groove CCP-b2 may have a concavely recessed shape based on the lower surface of the second non-folding portion NFP2 and the third non-folding portion NFP3, which is a flat surface. The first groove CCP-b1 may be defined as a continuous curved surface shape extending in the second direction DR2 between the first non-folding portion NFP1 and the second non-folding portion NFP2 spaced apart from each other in the first direction DR1, and the second groove CCP-b2 may be defined as a continuous curved surface shape extending in the second direction DR2 between the second non-folding portion NFP2 and the third non-folding portion NFP3 spaced apart from each other in the first direction DR1. Meanwhile, unlike what is illustrated, the first groove CCP-b1 and the second groove CCP-b2 may include an inclined surface and a groove flat surface like the groove CCP-a in FIG. 6B.

Referring to FIG. 6B, the groove CCP-a of the window WP-a according to an aspect of the present disclosure may include inclined surfaces SS1 and SS2. The groove CCP-a may have a concavely recessed shape based on a flat surface which is the upper surface of the first non-folding portion NFP1 and the second non-folding portion NFP2. The groove CCP-a may include a groove flat surface SFP and a first inclined surface SS1 and a second inclined surface SS2 spaced apart from each other in the first direction DR1 with the groove flat surface SFP interposed between the first inclined surface SS1 and the second inclined surface SS2. The groove flat surface SFP and the inclined surfaces SS1 and SS2 may be defined as a continuous flat and inclined surface shape extending in the second direction DR2. The first inclined surface SS1, the groove flat surface SFP, and the second inclined surface SS2 may have continuous surfaces without a discontinuity. The first inclined surface SS1, the groove flat surface SFP, and the second inclined surface SS2 may be adjacent and connected to each other. The boundary between the first inclined surface SS1 and the groove flat surface SFP and the boundary between the groove flat surface SFP and the second inclined surface SS2 may be smoothly connected to each other without a discontinuity or step difference, so that the upper surface of the groove CCP-a may have a continuous surface.

The shapes of the grooves CCP, CCP-a, CCP-b1, and CCP-b2 of the windows WP, WP-a, and WP-b illustrated in FIGS. 6A to 6C are exemplary, and the shapes of the grooves CCP, CCP-a, CCP-b1, and CCP-b2 may be changed according to the folding or bending characteristics required for the electronic device, etc. For example, depending on the folding or bending characteristics required for the electronic device, the radius of curvature in the groove CCP, CCP-b1, or CCP-b2 having a curved shape may be changed, the inclination angle or length of the inclined surfaces SS1 and SS2 in the groove CCP-a including the inclined surfaces and the width of the groove flat surface SFP between the inclined surfaces SS1 and SS2 may be changed, and when a plurality of grooves are included, the number and positions of the grooves may be changed.

The upper surface of the groove CCP, CCP-a, CCP-b1, or CCP-b2 exposed in the window WP, WP-a, or WP-b manufactured by the window manufacturing device according to an aspect of the present disclosure and the window manufacturing method according to an aspect of the present disclosure which are described later may be formed by reflecting the shape of the protruding portion and include a smooth curved surface without a discontinuity or an inclined surface without a discontinuity, which is continuously formed during the manufacturing process of the glass window.

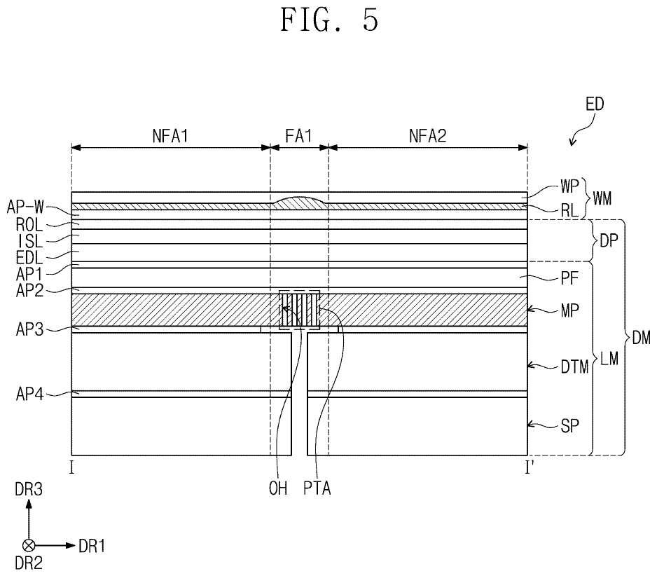

FIG. 7 is a block diagram of a window manufacturing device according to an aspect of the present disclosure. The window manufacturing device PM according to an easpect of the present disclosure may include a melting unit MTK and a shape processing unit SM. The window manufacturing device PM according to an aspect of the present disclosure may include a transfer unit TM for transferring a window processed in the shape processing unit SM. In the window manufacturing device PM according to an aspect of the present disclosure, the shape processing unit SM may be disposed between the melting unit MTK and the transfer unit TM. The window manufacturing device PM according to an aspect of the present disclosure may further include a cooling unit CM. In addition, the window manufacturing device PM according to an aspect of the present disclosure may further include a cutting unit CTM disposed after the transfer unit TM.

In the window manufacturing device PM according to an aspect of the present disclosure, the melting unit MTK may be a part to which glass raw materials are provided to form molten glass, or in which the molten glass is stored in a melted and mixed state. The melting unit MTK may be heated so that the glass raw materials are melted, or so that the molten glass is maintained in a melted state. The melting unit MTK may be directly controlled and heated, or may be heated by heat provided from a heating unit (not illustrated) provided as a component separate from the melting unit MTK to form molten glass. The melting unit MTK may include a discharge outlet, and the molten glass may be discharged through the discharge outlet, and the discharged molten glass may be provided to the shape processing unit SM.

The shape processing unit SM may be a part that introduces a recessed or protruding shape into preliminary glass, which has reached a semi-solidified state after being discharged from the melting unit MTK, or processes the preliminary glass so that the finally manufactured glass window has a uniform thickness. In addition, in an aspect of the present disclosure, the shape processing unit SM may simultaneously function as a cooling unit that cools the preliminary glass in a semi-solidified state to manufacture the glass window.

As the window manufacturing device PM according to an aspect of the present disclosure includes the shape processing unit SM disposed adjacent to the melting unit MTK, the preliminary glass in a semi-solidified state after being discharged from the melting unit MTK may be continuously processed. Accordingly, in the manufacturing of the window in which a groove or the like is formed, a window processing step using a separate device for shaping the groove may be omitted after producing a raw material glass sheet.

That is, the window manufacturing device PM according to an aspect of the present disclosure may have excellent process economy by integrating the manufacturing step of the raw material glass sheet and the shape processing step for having a shape required for the window into a single device when manufacturing the window and performing both steps together. In addition, the window manufacturing device PM according to an aspect of the present disclosure may prevent the occurrence of differences in the processed shape of a final glass window due to deviations in each processing step for shape processing by continuously processing the preliminary glass in a semi-solidified state through the shape processing unit SM after being discharged from the melting unit MTK. Accordingly, the grooves and the like of all the windows manufactured by the window manufacturing device PM according to an aspect of the present disclosure may have a uniform shape.

The window manufacturing device PM according to an aspect of the present disclosure may further include a cooling unit. The cooling unit CM may be disposed after the shape processing unit SM. The cooling unit CM may be a part that solidifies the preliminary glass, which has been processed in the shape processing unit SM, into the final glass window. The cooling unit CM may more uniformly correct the thickness of the preliminary glass processed in the shape processing unit SM.

Meanwhile, in an aspect of the present disclosure, the shape processing unit SM may function as an annealing unit that processes the shape of the preliminary glass while cooling the preliminary glass at the same time. When the shape processing unit SM simultaneously functions as an annealing unit, the shape processing unit SM may form a continuous groove in the semi-solidified preliminary glass and also slowly cool the preliminary glass to form a glass window having a predetermined thickness.

In an aspect of the present disclosure, in the window manufacturing device PM, when the shape processing unit SM simultaneously performs a cooling function, the shape processing unit SM may process the groove and change the semi-solidified state into a solidified glass window state. In this case, the thickness of the glass window may be corrected to be uniform by the cooling function of the shape processing unit SM.

The transfer unit TM may be disposed after the shape processing unit SM and serve to transfer the glass window processed so as to have the groove after passing through the shape processing unit SM. The transfer unit TM may move the glass window formed after being processed and cooled in the shape processing unit SM. In addition, the glass window may be additionally cooled while being transferred in the transfer unit TM. The transfer unit TM may be in the form of a plurality of guide rollers or in the form of a conveyor. However, the aspects of the present disclosure are not limited thereto.

The window manufacturing device PM according to an aspect of the present disclosure may further include a cutting unit CTM. The cutting unit CTM may be disposed after the shape processing unit SM. The cutting unit CTM may be a part that cuts the manufactured glass window so as to have a width or length finally required for the product or so as to have a specific three-dimensional shape.

That is, as the window manufacturing device PM according to an aspect of the present disclosure includes both the melting unit MTK configured to form molten glass and the shape processing unit SM disposed adjacent to the melting unit MTK and configured to perform a glass shaping process, it is possible to perform the manufacturing and shaping processes of the glass in a single device. Accordingly, process economy may be improved when the window is manufactured using the window manufacturing device PM according to an aspect of the present disclosure. In addition, as the window manufacturing device PM according to an aspect of the present disclosure includes the shape processing unit SM disposed after and adjacent to the melting unit MTK, the shape processing step of the glass may be performed on the preliminary glass in a semi-solidified state before it is fully solidified after being discharged from the melting unit MTK. In other words, by continuously processing the semi-solidified preliminary glass through the shape processing unit SM, the glass window manufactured by the window manufacturing device PM according to an aspect of the present disclosure may have a uniform groove shape throughout the entire glass window.

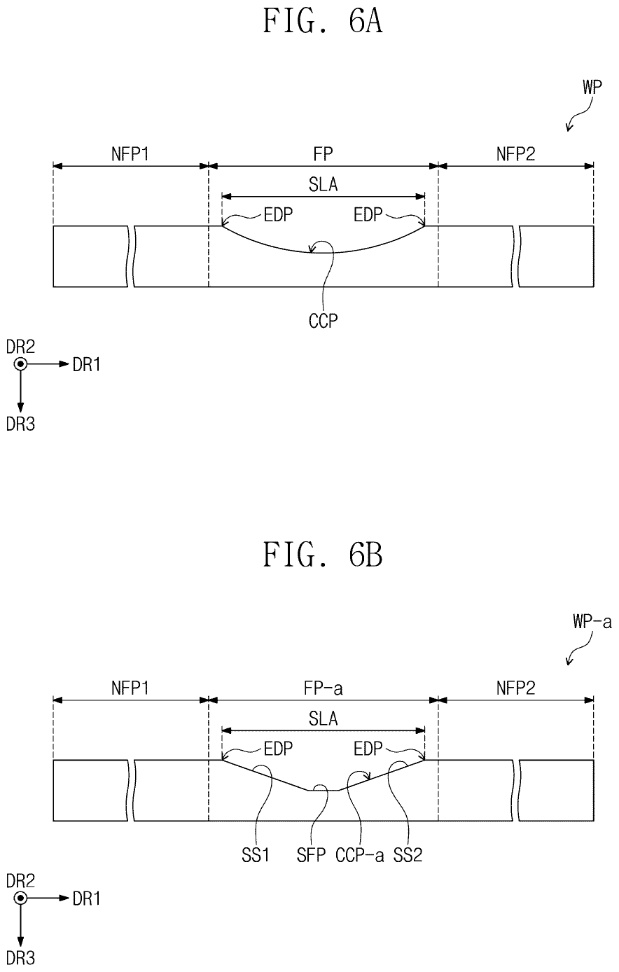

Hereinafter, window manufacturing devices according to an aspect of the present disclosure will be described with reference to FIGS. 8 to 12. In the descriptions of the window manufacturing devices according to an aspect of the present disclosure, the overlapping content described in the block diagram of FIG. 7 will not be repeated, and the features of the devices illustrated in FIGS. 8 to 12 will be primarily described.

FIG. 8 is a perspective view of a window manufacturing device according to an aspect of the present disclosure. FIG. 9A is a perspective view illustrating a shape processing unit according to an aspect of the present disclosure. FIG. 9B is a cross-sectional view of the shape processing unit according to an aspect of the present disclosure. FIG. 9B may be a cross-sectional view of a portion corresponding to line II-II′ of FIG. 9A. FIG. 9C is a cross-sectional view illustrating the shape processing unit according to an aspect of the present disclosure.

In an X-axis X, a Y-axis Y, and a Z-axis Z illustrated in FIG. 7 and the drawings below, the Z-axis Z direction is defined as an upward direction. In addition, the X-axis X and the Y-axis Y are orthogonal to each other, and the Z-axis Z may be a normal direction of a plane defined by the X-axis X and the Y-axis Y.

Meanwhile, the X-axis X may correspond to the third direction DR3 illustrated in the drawings described above, the Y-axis Y may correspond to the first direction DR1 illustrated in the drawings described above, and the Z-axis Z may correspond to the second direction DR2 illustrated in the drawings described above.

Referring to FIG. 8, a window manufacturing device PM-1 according to an aspect of the present disclosure may include a melting unit MTK and a shape processing unit SM-1. In addition, the window manufacturing device PM-1 according to an aspect of the present disclosure may include a transfer unit TM disposed after the shape processing unit SM-1. The shape processing unit SM-1 may be positioned on one side of the melting unit MTK. In an aspect of the present disclosure, the shape processing unit SM-1 may be disposed adjacent to the melting unit MTK in a direction parallel to a discharge direction EJD of molten glass discharged from the melting unit MTK. In an aspect of the present disclosure, the shape processing unit SM-1 may be spaced apart from the melting unit MTK by a predetermined distance GP and positioned below the shape processing unit SM-1 in the discharge direction EJD of the molten glass. The molten glass may be partially cooled and changed to a semi-solidified state before it is provided to the shape processing unit SM-1 after being discharged from the melting unit.

The molten glass may be discharged from the melting unit MTK and provided to the shape processing unit SM-1 in the form of preliminary glass P-WP by a down drawing method. Meanwhile, the method of discharging the molten glass and providing it as the preliminary glass P-WP is not limited to the down-drawing method, and any glass manufacturing method may be used without limitation as long as it can provide the molten glass as the preliminary glass P-WP in a semi-solidified state suitable for shape processing, such as a fusion method.

The shape processing unit SM-1 may process a groove included in the final glass window in a preliminary glass state which corresponds to a state before the molten glass discharged from the melting unit MTK is processed into the final glass window, and the shape processing unit SM-1 may control the thickness of the preliminary glass in consideration of the thickness of the final glass window.

In the window manufacturing device PM-1 illustrated in FIG. 8, the shape processing unit SM-1 may include a first sub-shape processing unit SMP-a and a second sub-shape processing unit SMP-b arranged to be spaced apart from each other with the preliminary glass P-WP interposed between the first sub-shape processing unit SMP-a and the second sub-shape processing unit SMP-b. The first sub-shape processing unit SMP-a and the second sub-shape processing unit SMP-b may be arranged to be spaced apart from each other by a predetermined separation distance DT in the X-axis X direction. The separation distance DT between the first sub-shape processing unit SMP-a and the second sub-shape processing unit SMP-b may be greater than or equal to the thickness of the window WP to be finally manufactured.

In FIG. 8, the separation distance DT between the first sub-shape processing unit SMP-a and the second sub-shape processing unit SMP-b in the X-axis X direction is illustrated as being maintained constant, but the aspects of the present disclosure are not limited thereto. For example, in an aspect of the present disclosure, the separation distance DT between the first sub-shape processing unit SMP-a and the second sub-shape processing unit SMP-b in the X-axis X direction may decrease as it goes toward the discharge direction EJD. In addition, in this case, the separation distance DT between the first sub-shape processing unit SMP-a and the second sub-shape processing unit SMP-b at the bottom of the shape processing unit SM-1 in the X-axis X direction may be substantially equal to the final thickness of the window WP.

Referring to FIGS. 8 to 9B, the shape processing unit SM-1 may have a three-dimensional plate shape including a flat surface and a protruding portion EP protruding from the flat surface FS-SM. The protruding portion EP may protrude toward a side facing the preliminary glass P-WP. The protruding portion EP may have a shape that extends continuously in the discharge direction EJD of the molten glass. Accordingly, the preliminary glass P-WP discharged and provided from the melting unit MTK may be continuously processed by the protruding portion EP.

One surface US-EP of the protruding portion EP may include a curved surface or an inclined surface. The shape of the protruding portion EP may be transferred onto the preliminary glass P-WP. The protruding portion EP includes a continuous curved surface or a continuous inclined surface without a step difference, and the shape of this continuous surface may be transferred onto the preliminary glass P-WP, thereby being able to manufacture the window WP in which a groove corresponding to the shape of the protruding portion EP is formed. The slimming region SLA of the window WP may include a portion in which the groove is formed.

In the shape processing unit SM-1 of the window manufacturing device PM-1 according to an aspect of the present disclosure, at least one of the first sub-shape processing unit SMP-a or the second sub-shape processing unit SMP-b arranged to be spaced apart from each other with the preliminary glass P-WP interposed between the first sub-shape processing unit SMP-a and the second sub-shape processing unit SMP-b may include at least one protruding portion EP.

In FIGS. 9A and 9B, the shape processing unit SM-1 is exemplarily illustrated as representing any one of the first sub-shape processing unit SMP-a and the second sub-shape processing unit SMP-b. Referring to FIGS. 9A and 9B, the shape processing unit SM-1 may include a protruding portion EP protruding from the flat surface FS-SM. The shape processing unit SM-1 may include a protruding region JEP-1 including the protruding portion EP and flat regions JFP1-1 and JFP2-1 including the flat surface FS-SM.

The surfaces of the flat regions of the preliminary glass P-WP arranged to be spaced apart from each other with the slimming region SLA interposed between the flat regions may be uniformly processed by the flat surface of the shape processing unit SM-1. The window WP (see FIG. 6A) according an aspect of the present disclosure, which is described above, may be manufactured by the window manufacturing device PM-1 according to an aspect of the present disclosure which includes the shape processing unit SM-1 according to an aspect of the present disclosure illustrated in FIGS. 9A and 9B.

Meanwhile, the shape processing unit SM-1 according to an aspect of the present disclosure illustrated in FIGS. 9A and 9B is illustrated as including one protruding portion in the sub-shape processing unit, but the aspects of the present disclosure are not limited thereto, and the sub-shape processing unit may include a plurality of protruding portions.

A shape processing unit SM-1a according to an aspect of the present disclosure illustrated in FIG. 9C corresponds to a case in which all of the two sub-shape processing units facing each other include a protruding portion EP.

Both a first sub-shape processing unit SMP-a1 and a second sub-shape processing unit SMP-b1 include protruding portions EP, and the protruding portion EP of the first sub-shape processing unit SMP-a1 and the protruding portion EP of the second sub-shape processing unit SMP-b1 may not overlap each other in the X-axis X direction.

Each of the first sub-shape processing unit SMP-a1 and the second sub-shape processing unit SMP-b1 may include a protruding region JEP-a or JEP-b and a first flat region JFP1-a or JFP1-b and a second flat region JFP2-a or JEP2-b spaced apart from each other in the Y-axis Y direction with the protruding region JEP-a or JEP-b between the first flat region JFP1-a or JFP1-b and the second flat region JFP2-a or JEP2-b. For example, in an aspect of the present disclosure illustrated in FIG. 9C, the first sub-shape processing unit SMP-a1 may have the first flat region JFP1-a with a width greater than that of the second flat region JFP2-a in the Y-axis Y direction, while the second sub-shape processing unit SMP-b1 may have the first flat region JFP1-b with a width smaller than that of the second flat region JFP2-b in the Y-axis Y direction. That is, a window manufactured using the shape processing unit SM-1a illustrated in FIG. 9C may include two non-overlapping grooves in the thickness direction. For example, a window WP-b according to the aspect of the present disclosure described with reference to FIG. 6C may be manufactured using the shape processing unit SM-1a according to an aspect of the present disclosure illustrated in FIG. 9C.

Meanwhile, the shape and arrangement position of the shape processing unit SM-1 or SM-1a and the protruding portion EP included therein illustrated and described in FIGS. 9A to 9C are exemplary, and the form of the shape processing unit SM-1 or SM-1a may be changed and applied according to the required glass window in consideration of the folding form of the electronic device and the arrangement form of the folding region.

In the window manufacturing device PM-1 illustrated in FIG. 8, the shape processing unit SM-1 may be positioned to be spaced apart from the melting unit MTK at a predetermined distance. While the process of manufacturing the window is in progress with the window manufacturing device PM-1, the shape processing unit SM-1 may be fixedly arranged to be spaced apart from the melting unit MTK. Accordingly, as the preliminary glass P-WP in a semi-solidified state is continuously supplied from the melting unit MTK to the shape processing unit SM-1 adjacent thereto in the discharge direction, a portion of the supplied preliminary glass P-WP may be pressed and deformed by a pressure applied by the protruding portion EP, etc.

The window manufacturing device PM-1 according to an aspect of the present disclosure may include a plurality of guide rollers GRL-U1, GRL-U2, GRL-B1, and GRL-B2 as a transfer unit TM. Referring to FIG. 8, in an aspect of the present disclosure, the transfer unit TM includes an upper transfer unit GRL-U disposed adjacent to the shape processing unit SM-1 and a lower transfer unit GRL-B disposed after the upper transfer unit GRL-U, and each of the upper transfer unit GRL-U and the lower transfer unit GRL-B may include a pair of guide rollers GRL-U1 and GRL-U2 or GRL-B1 and GRL-B2 facing each other. The guide rollers GRL-U1, GRL-U2, GRL-B1, and GRL-B2 may continuously move the window WP being processed while passing through the shape processing unit SM-1 by a roll rotation operation MVD.

Meanwhile, the configuration of the transfer unit TM in FIG. 8 is exemplary, and the aspects of the present disclosure are not limited thereto. The transfer unit TM of the window manufacturing device PM-1 according to an aspect of the present disclosure may further include an additional roller, a conveyor device, or the like in addition to the guide rollers illustrated in FIG. 8, etc., or some of the guide rollers illustrated in FIG. 8 may be omitted from the transfer unit TM.

As the window manufacturing device PM-1 including the shape processing unit SM-1 or SM-1a according to an aspect of the present disclosure described with reference to FIGS. 8 to 9C includes the protruding portion EP extending in one direction, a groove may be continuously formed in the preliminary glass discharged from the melting unit MTK and provided to the shape processing unit SM-1 or SM-1a.

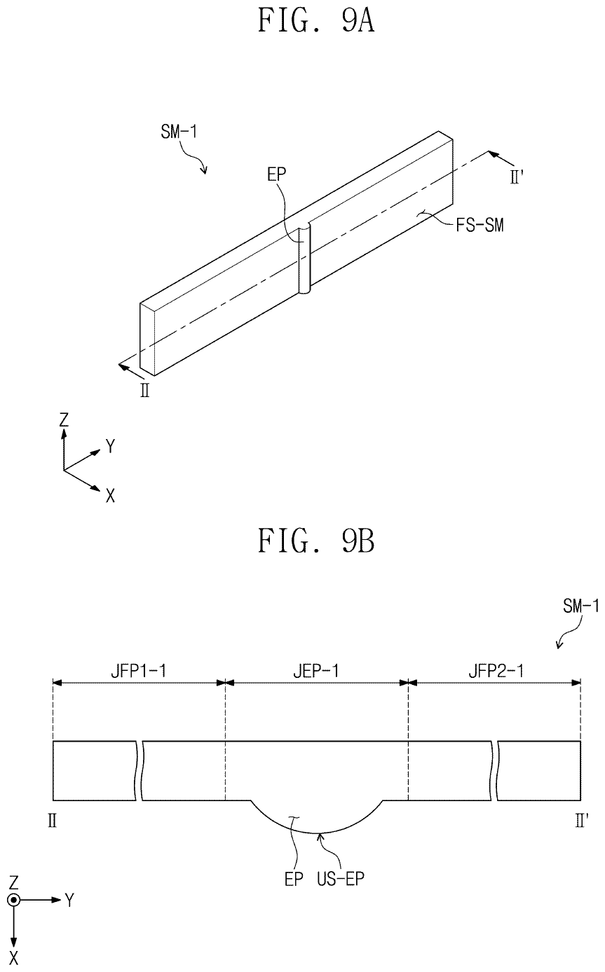

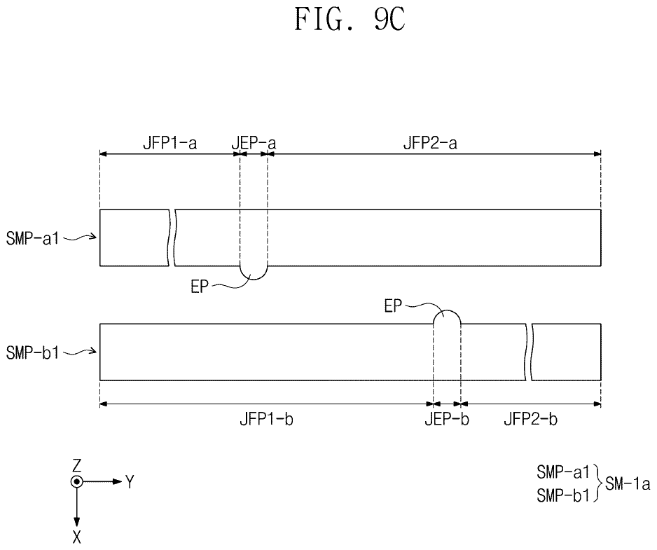

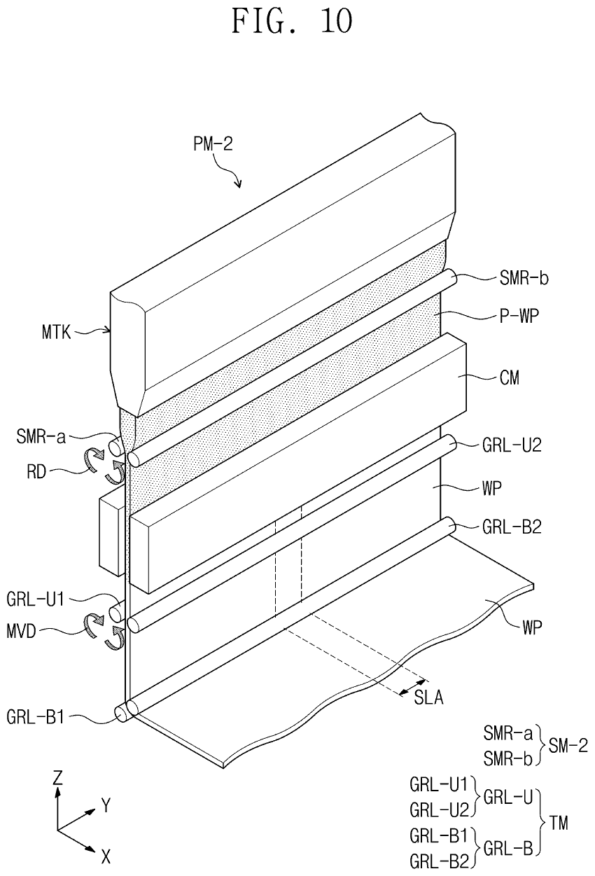

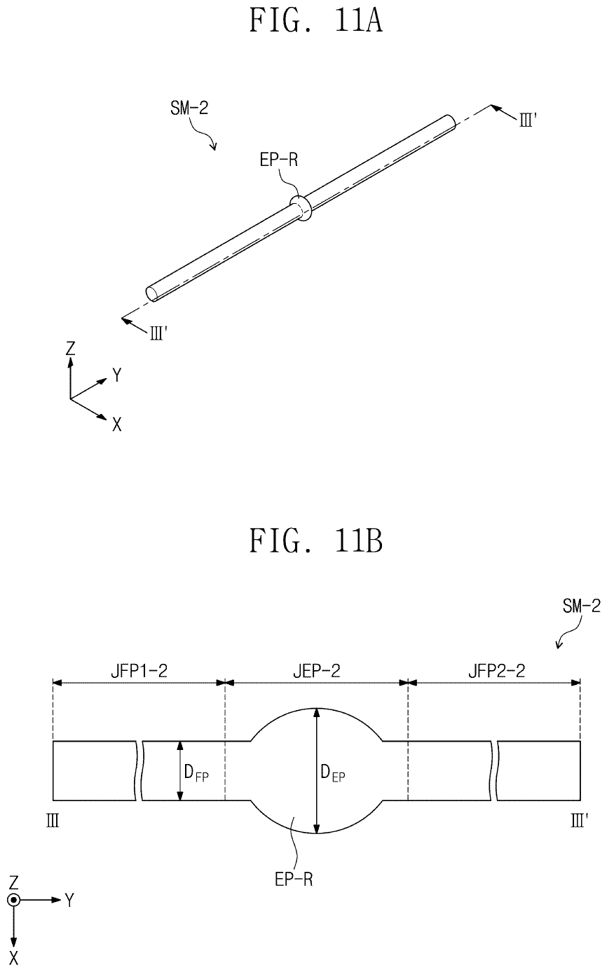

FIG. 10 is a perspective view of a window manufacturing device according to an aspect of the present disclosure. FIG. 11A is a perspective view of a shape processing unit according to an aspect of the present disclosure. FIG. 11B is a cross-sectional view of the shape processing unit according to an aspect of the present disclosure. FIG. 11B may be a cross-sectional view of a portion corresponding to line III-III′ of FIG. 11A. FIG. 12 is a cross-sectional view illustrating the shape processing unit according to an aspect of the present disclosure.

A window manufacturing device PM-2 according to an aspect of the present disclosure may include a melting unit MTK and a shape processing unit SM-2 disposed on one side of the melting unit MTK. The window manufacturing device PM-2 according to an aspect of the present disclosure may include a cooling unit CM disposed after the shape processing unit SM-2. The window manufacturing device PM-2 according to an aspect of the present disclosure may include a transfer unit TM, and the cooling unit CM may be disposed between the shape processing unit SM-2 and the transfer unit TM. In an aspect of the present disclosure, the cooling unit CM may be disposed after the shape processing unit SM-2 to further cool the preliminary glass P-WP processed in the shape processing unit SM-2 so that the window WP in a solidified form can be finally manufactured. The cooling unit CM may be controlled so that a cooling step proceeds as an annealing process, ensuring that the thickness of the preliminary glass P-WP is uniformly formed.

Compared to the window manufacturing device PM-1 according to the aspect of the present disclosure illustrated in FIG. 8, the window manufacturing device PM-2 according to an aspect of the present disclosure illustrated in FIG. 10 has a difference in the form of the shape processing unit.

In the window manufacturing device PM-2 according to an aspect of the present disclosure illustrated in FIG. 10, the shape processing unit SM-2 may include a first sub-shape processing unit SMR-a and a second sub-shape processing unit SMR-b spaced apart from each other in the X-axis X direction. In an aspect of the present disclosure, each of the first sub-shape processing unit SMR-a and the second sub-shape processing unit SMR-b may be in the form of a roller. Accordingly, the first sub-shape processing unit SMR-a may be referred to as a first sub-roller, and the second sub-shape processing unit SMR-b may be referred to as a second sub-roller.

Referring to FIGS. 11A and 11B, the shape processing unit SM-2 may include a protruding portion EP-R. The first sub-shape processing unit SMR-a and the second sub-shape processing unit SMR-b having a roller shape may process the provided preliminary glass P-WP by a rotational operation RD. At least one of the first sub-shape processing unit SMR-a or the second sub-shape processing unit SMR-b of the shape processing unit SM-2 may include at least one protruding portion EP-R. One or more protruding portions EP-R may be included in any one of the first sub-shape processing unit SMR-a and the second sub-shape processing unit SMR-b. Alternatively, unlike this, one protruding portion EP-R may be included in each of the first sub-shape processing unit SMR-a and the second sub-shape processing unit SMR-b.

In the shape processing unit SM-2 according to an aspect of the present disclosure, the protruding portion EP-R may correspond to a portion having a larger diameter than other portions of the shape processing unit. The shape processing unit SM-2 may include a protruding region JEP-2 including the protruding portion EP-R, and a first flat region JFP1-2 and a second flat region JFP2-2 spaced apart from each other in one direction with the protruding region JEP-2 interposed between the first flat region JFP1-2 and the second flat region JFP2-2. A diameter DEP of the protruding portion EP-R included in the protruding region JEP-2 may be larger than a diameter DFP of the flat region JFP1-2 or JFP2-2.

Accordingly, a groove may be formed in the preliminary glass P-WP in a portion corresponding to the protruding portion EP-R. The shape of the protruding portion EP-R is transferred onto the preliminary glass P-WP to form a groove, and the window WP including the slimming region SLA in which the groove is formed may be manufactured by the window manufacturing device PM-2 according to an aspect of the present disclosure.

The first sub-shape processing unit SMR-a and the second sub-shape processing unit SMR-b may perform a rotational operation RD with the preliminary glass P-WP interposed between the first sub-shape processing unit SMR-a and the second sub-shape processing unit SMR-b, transferring the shape of the protruding portion EP-R onto the preliminary glass P-WP and moving the preliminary glass P-WP toward the cooling unit CM.

The window manufacturing device PM-2 according to an aspect of the present disclosure may include a cooling unit CM disposed after the shape processing unit SM-2. In the cooling unit CM, the preliminary glass P-WP may be cooled and solidified to finally form the window WP. When the preliminary glass is cooled to be solidified in the cooling unit CM after the groove is formed, surface correction may occur so that the exposed surface of the groove has uniform surface characteristics due to the slight fluidity of the preliminary glass P-WP.

The window manufacturing device PM-2 according to an aspect of the present disclosure may include a transfer unit TM disposed after the cooling unit CM. The transfer unit TM may include a plurality of guide rollers GRL-U1, GRL-U2, GRL-B1, and GRL-B2. As described with reference to FIG. 8, each of the upper transfer unit GRL-U and the lower transfer unit GRL-B may include a pair of guide rollers GRL-U1 and GRL-U2 or GRL-B1 and GRL-B2 facing each other. The guide rollers GRL-U1, GRL-U2, GRL-B1, and GRL-B2 may continuously move the window WP being processed while passing through the shape processing unit SM-1 by a roll rotation (MVD) operation.

FIG. 12 illustrates a cross-sectional view illustrating another form of a protruding portion in the shape processing unit according to an aspect of the present disclosure and an enlarged plan view of a portion SFA of the surface of the protruding portion.

A protruding portion EP-Ra may include a micro pattern defined on the surface thereof. The micro pattern may be defined as a sub-protruding portion SEP and a sub-groove SHP disposed between sub-protruding portions SEP. Micro patterns may be defined on the surface of the exposed protruding portion EP-Ra, and accordingly, the micro patterns may also be formed in the groove of the window formed after the shape of the protruding portion EP-Ra has been transferred. When deformation occurs in the slimming region of the window formed to include the slimming region in which the micro patterns are formed, stress may be distributed due to the micro patterns, thus improving reliability during folding or bending operations.

In an aspect of the present disclosure, the micro pattern may have a honeycomb pattern shape on a plane. However, the aspects of the present disclosure are not limited thereto.

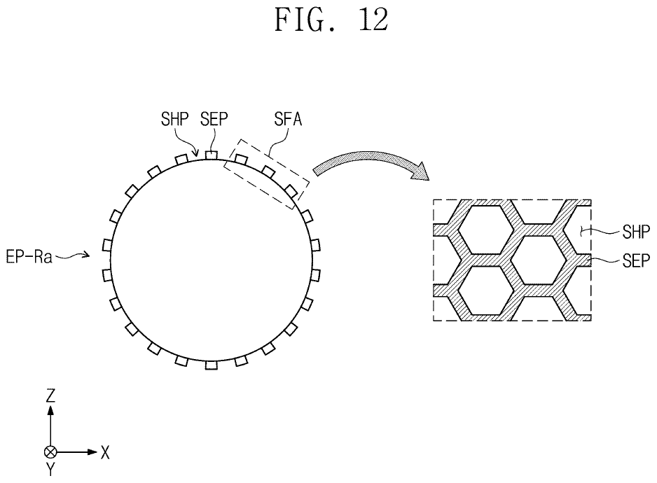

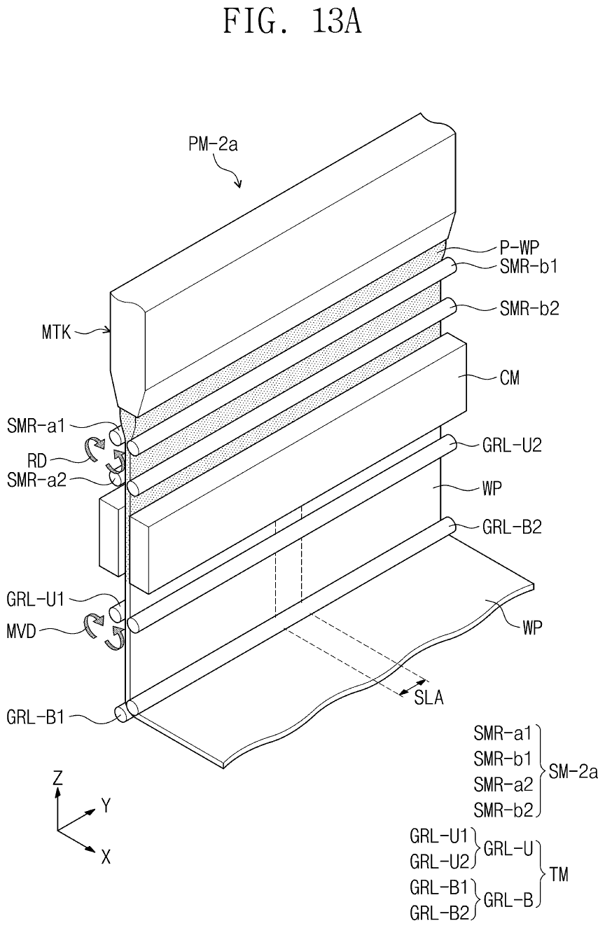

FIG. 13A is a perspective view illustrating a window manufacturing device according to an aspect of the present disclosure. FIG. 13B is a perspective view of a shape processing unit according to an aspect of the present disclosure. FIG. 13B exemplarily illustrates only a portion of the configuration of the shape processing unit in FIG. 13A.

A window manufacturing device PM-2a according to an aspect of the present disclosure is different from the window manufacturing device PM-2 according to the aspect of the present disclosure described with reference to FIG. 10 in that a shape processing unit SM-2a includes a plurality of shape processing units sequentially arranged in the Z-axis Z direction.

The shape processing unit SM-2a of the window manufacturing device PM-2a according to an aspect of the present disclosure may include upper shape processing units SMR-a1 and SMR-b1 and lower shape processing units SMR-a2 and SMR-b2 sequentially disposed in the Z-axis Z direction parallel to the discharge direction of the molten glass. Each of the shape processing units overlapping each other in the Z-axis Z direction in the upper shape processing units SMR-a1 and SMR-b1 and the lower shape processing units SMR-a2 and SMR-b2 may include a protruding portion EP-R.

The upper shape processing units SMR-a1 and SMR-b1 may include a first upper shape processing unit SMR-a1 and a second upper shape processing unit SMR-b1 facing each other with the preliminary glass P-WP interposed between the first upper shape processing unit SMR-a1 and the second upper shape processing unit SMR-b1. The lower shape processing units SMR-a2 and SMR-b2 may include a first lower shape processing unit SMR-a2 and a second lower shape processing unit SMR-b2 facing each other with the preliminary glass P-WP interposed between the first lower shape processing unit SMR-a2 and the second lower shape processing unit SMR-b2.

Referring to FIG. 13B, the protruding portion EP-R of the first upper shape processing unit SMR-a1 and the protruding portion EP-R of the first lower shape processing unit SMR-a2 may be disposed to overlap each other. As the protruding portions EP-R included in the upper and lower shape processing units are disposed to overlap each other, the preliminary glass P-WP may be processed in the overlapping portion while passing through the upper shape processing unit SMR-a1 and the lower shape processing unit SMR-a2. Accordingly, the surface of the groove formed in the slimming region SLA may exhibit more uniform appearance quality.

Meanwhile, in FIG. 13B, the protruding portion EP-R of the first upper shape processing unit SMR-a1 and the protruding portion EP-R of the first lower shape processing unit SMR-a2 are illustrated as having the same size and shape, but the aspects of the present disclosure are not limited thereto.

For example, the diameter of the protruding portion EP-R of the first lower shape processing unit SMR-a2 on a cross section may be larger than the diameter of the protruding portion EP-R of the first upper shape processing unit SMR-a1. In this case, the groove may be additionally processed to be more concave by the protruding portion EP-R along the movement direction of the preliminary glass P-WP. In addition, in an aspect of the present disclosure, the shape processing unit SM-2a may include three or more shape processing units whose protruding portions overlap each other in the Z-axis Z direction. As the number of shape processing units including the protruding portions at the overlapping positions increases, the amount of processing (i.e., the degree of concaveness of the groove) of the groove processed by the protruding portions increases, and the consistency and precision of the groove shape may be improved.

Hereinafter, a window manufacturing method according to an aspect of the present disclosure will be described with reference to drawings. In the description of the window manufacturing method according to an aspect of the present disclosure, the overlapping content described with reference to FIGS. 1 to 13B will not be described again, and differences will be primarily described.

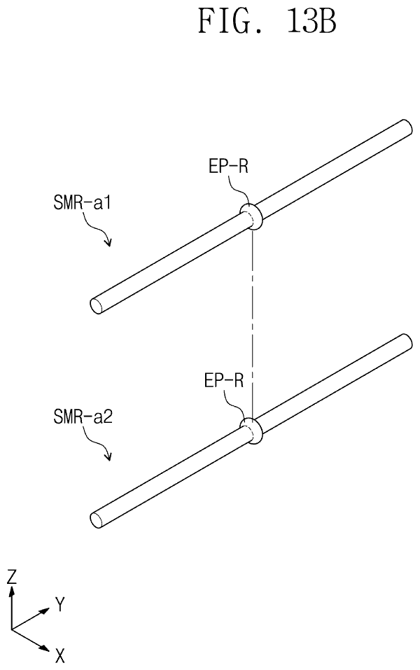

FIG. 14 is a flowchart of a window manufacturing method according to an aspect of the present disclosure. The window manufacturing method (100) according to an aspect of the present disclosure may include manufacturing molten glass (S10), providing preliminary glass in a semi-solidified state to a shape processing unit (S30), forming a groove in the preliminary glass (S50), and cooling the preliminary glass (S70).

As the window manufacturing method (100) according to an aspect of the present disclosure includes providing semi-solidified preliminary glass to a shape processing unit and forming a groove in the semi-solidified preliminary glass in the shape processing unit, it is possible to continuously perform the manufacturing of a raw material glass sheet and the shape processing of a glass window having a slimming region, thereby having excellent process economy.

The manufacturing of molten glass (S10) may be providing glass raw materials to a melting unit, melting and mixing the glass raw materials, and forming the molten glass.

The providing of preliminary glass in a semi-solidified state to a shape processing unit (S30) may be providing the molten glass, which is discharged from the melting unit, to the shape processing unit in the form of semi-solidified preliminary glass. The semi-solidified state may mean a state in which deformation is possible when pressure is applied or a processing unit having a specific shape is contacted. The preliminary glass may refer to the entire range between a liquid state while being stored in the melting unit or immediately after being discharged from the melting unit and a state in which it is completely solidified after cooling and becomes a glass window.

The providing of the preliminary glass to the shape processing unit (S30) may include continuously moving the preliminary glass from the melting unit to the shape processing unit in the discharge direction of the molten glass.

After the providing of the preliminary glass to the shape processing unit (S30), the forming of a groove in the preliminary glass (S50) may be performed continuously. The forming of a groove in the preliminary glass (S50) may be forming a groove in the preliminary glass provided to the shape processing unit by using the protruding portion of the shape processing unit.

The forming of a groove in the preliminary glass (S50) may include disposing the shape processing unit to be adjacent to the preliminary glass or operating the shape processing unit so that the shape of the protruding portion is transferred onto the preliminary glass. For example, when a window is manufactured using the window manufacturing device of FIG. 8 described above, the forming of a groove in the preliminary glass (S50) may be performed by fixedly disposing the shape processing unit SM-1 so that the protruding portion EP of the shape processing unit SM-1 is adjacent to the preliminary glass. In addition, when a window is manufactured using the window manufacturing device of FIG. 10 described above, the forming of a groove in the preliminary glass (S50) may be performed by disposing the shape processing unit SM-2 so that the protruding portion EP-R of the shape processing unit SM-2 is adjacent to the preliminary glass and rotating the shape processing unit SM-2.

The forming of a groove in the preliminary glass (S50) may be continuously forming a groove in the preliminary glass with a protruding portion. The preliminary glass in a semi-solidified state may be provided to a shape processing unit, and then the preliminary glass may be moved by continuously passing through the shape processing unit so that a groove shape may be sequentially processed in the provided preliminary glass.

The window manufacturing method (100) according to an aspect of the present disclosure may include cooling the preliminary glass (S70). The cooling of the preliminary glass (S70) may be performed simultaneously with or after the forming of a groove in the preliminary glass (S50).

In the shape processing unit of the window manufacturing device according to an aspect of the present disclosure, the forming of a groove in the preliminary glass (S50) and the cooling of the preliminary glass (S70) may be performed simultaneously. In addition, when the window manufacturing device according to an aspect of the present disclosure includes a cooling unit disposed after the shape processing unit, the cooling of the preliminary glass (S70) may be additionally performed after the forming of a groove in the preliminary glass (S50).

In the cooling unit, the preliminary glass may be cooled to form a solidified glass window. When the glass window is formed in the cooling unit, the thickness of the glass window may be corrected. Accordingly, after the cooling of the preliminary glass (S70), the glass window may exhibit a uniform thickness and excellent surface properties.

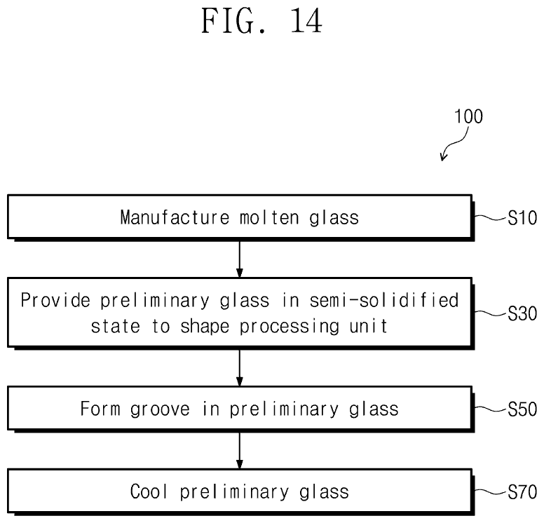

FIG. 15 is a cross-sectional view exemplarily illustrating one step of the window manufacturing method in the window manufacturing device PM according to an aspect of the present disclosure.

In the melting unit MTK, molten glass MTG is manufactured, and the molten glass may be discharged in the discharge direction EJD and changed into semi-solidified preliminary glass P-WP. The preliminary glass P-WP may be provided to the shape processing unit SM. The shape processing unit SM may be disposed adjacent to the melting unit MTK in the discharge direction EJD of the molten glass.

The shape processing unit SM may be disposed below the discharge direction EJD of the molten glass and receive the preliminary glass which is transformed into a sheet shape as the molten glass is partially cooled and semi-solidified. The shape processing unit SM may include a first sub-shape processing unit SM-a and a second sub-shape processing unit SM-b facing each other in the thickness direction of the preliminary glass P-WP. In an aspect of the present disclosure illustrated in FIG. 15, the first sub-shape processing unit SM-a may include a protruding portion EP. The protruding portion EP may have a shape that protrudes so as to be adjacent to the preliminary glass P-WP. The protruding portion EP may have a shape that extends in a direction parallel to the discharge direction EJD. Accordingly, the shape of the protruding portion EP may be transferred onto the surface of the preliminary glass P-WP moving along the protruding portion EP, thereby forming a groove in the preliminary glass P-WP.

In an aspect of the present disclosure, the shape processing unit SM may function as a cooling unit, and a window WP having a groove formed therein may be finally manufactured by passing through the shape processing unit SM.

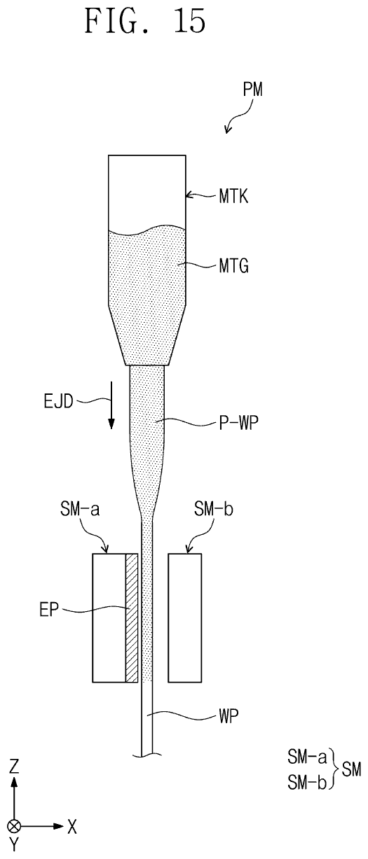

FIG. 16 exemplarily illustrates a portion of the forming of a groove in the preliminary glass (S50). Referring to FIG. 16, a groove CCP of the preliminary glass P-WP may be formed along the shape of the protruding portion EP of the first sub-shape processing unit SM-a. The shape of the protruding portion EP may be transferred to form the groove CCP on one surface of the preliminary glass P-WP. The remaining portions of the shape processing unit SM-a and SM-b excluding the protruding portion EP may have flat surfaces adjacent to the preliminary glass P-WP, and the remaining portions of the preliminary glass P-WP excluding the groove CCP may be processed to have uniform surface characteristics by these flat surfaces.

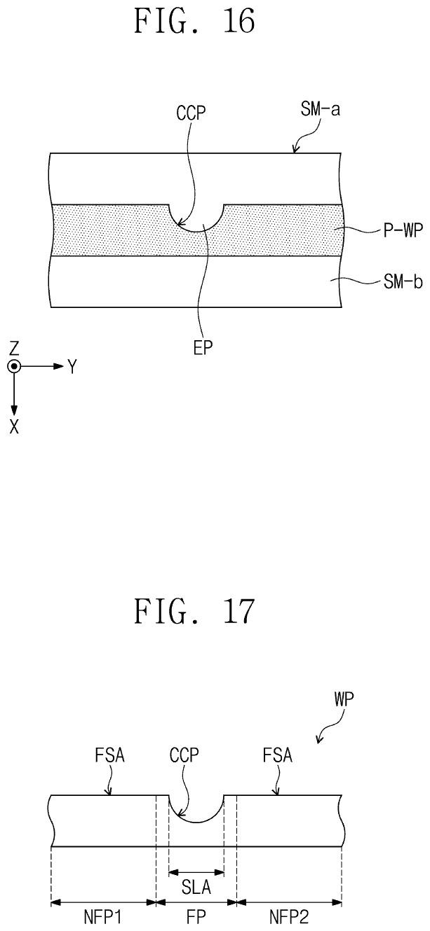

FIG. 17 is a cross-sectional view illustrating a window manufactured by the window manufacturing method according to an aspect of the present disclosure. The window manufactured by the window manufacturing method according to an aspect of the present disclosure may be a glass window including a groove CCP. The region in which the groove CCP is formed in the window WP may be referred to as a slimming region SLA. The window WP may be manufactured to have a folding portion FP including the slimming region SLA, in which the groove CCP is defined, and non-folding portions NFP1 and NFP2 corresponding to flat regions FSA.

The window manufactured by the window manufacturing device according to an aspect of the present disclosure and the window manufacturing method according to an aspect of the present disclosure may have a uniform surface on the exposed surface of the groove. In addition, since the manufacturing of the window, shaped from glass raw materials, is continuously performed in a single manufacturing device, the manufactured window may exhibit uniform quality characteristics.

As the window manufacturing device according to an aspect of the present disclosure includes a shape processing unit disposed after a melting unit and having a protruding portion corresponding to a groove shape required for the window, glass manufacturing and slimming region processing may be continuously performed in a single device. Accordingly, the window manufactured by the window manufacturing device according to an aspect of the present disclosure may have excellent processing characteristics and uniform surface quality.

As the window manufacturing method according to an aspect of the present disclosure includes providing semi-solidified preliminary glass to a shape processing unit and forming a groove using a protruding portion in the shape processing unit, a glass window having a slimming region can be manufactured by continuously forming the groove after manufacturing molten glass, thereby being able to omit a separate process for glass shape processing and exhibit improved process economy.

Although the above has been described with reference to aspects of the present disclosure, those skilled in the art or those of ordinary skill in the art will understand that various modifications and changes can be made to aspects of the present disclosure within the scope that does not depart from the spirit and technical field of the disclosure and the claims to be described later.

Accordingly, the technical scope of the disclosure should not be limited to the content described in the detailed description of the specification, but should be determined by the claims described hereinafter.

What is claimed is:

1. A window manufacturing device comprising:
a melting unit configured to supply molten glass; and
a shape processing unit disposed adjacent to the melting unit in a discharge direction, wherein the molten glass is discharged from the melting unit in the discharge direction, and wherein the shape processing unit comprises a protruding portion configured to form a groove in a semi-solidified preliminary glass formed from the molten glass discharged from the melting unit.

2. The window manufacturing device of claim 1, wherein the shape processing unit comprises:
a first sub-shape processing unit and a second sub-shape processing unit spaced apart from each other in a thickness direction of the semi-solidified preliminary glass with the semi-solidified preliminary glass interposed between the first sub-shape processing unit and the second sub-shape processing unit, and
wherein at least one of the first sub-shape processing unit or the second sub-shape processing unit comprises the at least one protruding portion.

3. The window manufacturing device of claim 1, wherein the protruding portion extends in a direction parallel to the discharge direction and wherein the protruding portion protrudes toward the semi-solidified preliminary glass so as to transfer the shape of the protruding portion onto the semi-solidified preliminary glass.

4. The window manufacturing device of claim 3, wherein the shape processing unit comprises:
a protruding region comprising the protruding portion; and
a first flat region and a second flat region spaced apart from each other with the protruding region interposed between the first flat region and the second flat region, wherein the first flat region and the second flat region each comprise a flat surface.

5. The window manufacturing device of claim 3, wherein the shape processing unit is fixedly disposed at a position spaced apart from the melting unit in the discharge direction by a predetermined distance.

6. The window manufacturing device of claim 5, wherein the shape processing unit forms the groove in the semi-solidified preliminary glass and cools the semi-solidified preliminary glass.

7. The window manufacturing device of claim 1, wherein the shape processing unit comprises a roller including the protruding portion.

8. The window manufacturing device of claim 7, wherein the roller comprises:
a protruding region comprising the protruding portion; and
a first flat region and a second flat region spaced apart from each other with the protruding region interposed between the first flat region and the second flat region,
wherein a diameter of the protruding region is larger than a diameter of the first flat region and a diameter of the second flat region.

9. The window manufacturing device of claim 7, further comprising a cooling unit spaced apart from the melting unit with the shape processing unit interposed between the cooling unit and the melting unit.

10. The window manufacturing device of claim 7, wherein the shape processing unit comprises:
a first sub-roller and a second sub-roller spaced apart from each other in the thickness direction of the semi-sold preliminary glass with the semi-solid preliminary glass interposed between the first sub-roller and the second sub-roller,
wherein at least one of the first sub-roller or the second sub-roller comprises the at least one protruding portion.

11. The window manufacturing device of claim 10, wherein the first sub-roller and the second sub-roller are configured to rotate with the semi-solid preliminary glass interposed between the first sub-roller and the second sub-roller, such that a shape of the protruding portion is transferred onto the semi-solid preliminary glass and the semi-solid preliminary glass is movable between the first sub-roller and the second sub-roller.

12. The window manufacturing device of claim 1, wherein the shape processing unit comprises:
an upper shape processing unit and a lower shape processing unit sequentially disposed in the discharge direction, wherein the upper shape processing unit and the lower shape processing unit each comprise a protruding portion,
wherein the protruding portion of the upper shape processing unit and the protruding portion of the lower shape processing unit overlap each other in the discharge direction.

13. The window manufacturing device of claim 1, wherein a surface of the protruding portion comprises a micro pattern including a plurality of sub-protruding portions.

14. The window manufacturing device of claim 1, further comprising a transfer unit configured to move a solidified glass window formed from the semi-solidified preliminary glass processed in the shape processing unit.

15. A window manufacturing method using a window manufacturing device that comprises a melting unit and a shape processing unit including a protruding portion, the method comprising:
providing glass raw materials to the melting unit to manufacture a molten glass;
discharging the molten glass from the melting unit to provide a semi-solidified preliminary glass to the shape processing unit;
forming a groove in the semi-solidified preliminary glass using the protruding portion in the shape processing unit; and
cooling the semi-solidified preliminary glass.

16. The method of claim 15, wherein the forming the groove in the semi-solidified preliminary glass and the cooling the semi-solidified preliminary glass are performed simultaneously in the shape processing unit.

17. The method of claim 15, wherein the forming the groove in the semi-solidified preliminary glass comprises:
disposing the shape processing unit to be adjacent to the semi-solidified preliminary glass; or
operating the shape processing unit so that a shape of the protruding portion is transferred onto the semi-solidified preliminary glass.

18. The method of claim 15, wherein:
the window manufacturing device further comprises a cooling unit disposed after the shape processing unit; and
a thickness of a window is corrected in the cooling unit.

19. The method of claim 15, wherein the semi-solidified preliminary glass is continuous provided to the shape processing unit by moving the semi-solidified preliminary glass from the melting unit to the shape processing unit in a discharge direction of the molten glass from the melting unit.

20. The method of claim 19, wherein the forming of the groove in the semi-solidified preliminary glass comprises continuously forming the groove in the semi-solidified preliminary glass by the protruding portion.
